(19) United States
(12) Patent Application Publication
(10) Pub. No.: US 2024/0144088 A1
(43) Pub. Date: May 2, 2024

(54) MACHINE LEARNING ENABLED INTERACTION SUMMARIZATION AND ANALYSIS

(71) Applicant: CallMiner, Inc., Waltham, MA (US)

(72) Inventors: Richard A. Britt, St. Petersburg, FL (US); Michael C. Dwyer, Fort Myers, FL (US); Bruce K. McMahon, Lunenburg, CA (US); Roderick A. MacQueen, Fort Myers, FL (US); Douglas J. Sudd, Fort Myers, FL (US); Jeffrey A. Gallino, Lexington, MA (US)

(21) Appl. No.: 18/384,232

(22) Filed: Oct. 26, 2023

Related U.S. Application Data
(60) Provisional application No. 63/419,903, filed on Oct. 27, 2022.
(60) Provisional application No. 63/419,902, filed on Oct. 27, 2022.
(60) Provisional application No. 63/419,942, filed on Oct. 27, 2022.

(51) Int. Cl. G06N 20/00; G10L 15/06; G10L 15/08; G10L 15/22

(52) U.S. Cl. CPC G06N 20/00; G10L 15/063; G10L 15/08; G10L 15/22

(57) ABSTRACT

Disclosed herein is an interaction summarization system for automatically generating summary output. The interaction summarization system generates a transcript from an interaction including content, the content including at least one of written text, audio speech, non-word symbols, metadata, silences, language characteristics, or acoustic characteristics, wherein the content is attributed to a participant in the interaction, and generates an interaction summary of the transcript using at least one of an extractive machine learning summarization model or an abstractive machine learning summarization model that summarizes the content of the interaction.

### CLAIM TO PRIORITY

This application claims the benefit of and priority to the following provisional applications, each of which is hereby incorporated by reference in its entirety: U.S. Patent Application Ser. No. 63/419,903, filed Oct. 27, 2022 (CALL-0005-P01); U.S. Patent Application Ser. No. 63/419,902, filed Oct. 27, 2022 (CALL-0006-P01); and U.S. Patent Application Ser. No. 63/419,942, filed Oct. 27, 2022 (CALL-0007-P01).

### BACKGROUND

### Field

The disclosure herein relates to tools enabled by machine learning to perform interaction analysis and summarization, agent training and chat analytics to provide automated coaching enhancement via robotic training, and more particularly, robot-enabled training delivery to a human customer service agent, automated coaching and meeting analytics, and an employee engagement, retention, churn, and prediction platform.

### Description of the Related Art

Previously, interaction data from calls, chats, messages, video conferences, meetings, and the like, which may include real time interactions or past interactions, was analyzed using word, phrase, and pattern recognition which could be cumbersome and required that words, phrases, and patterns explicitly appear on a list. In the case of recorded interactions, the data may involve thousands of hours of audio calls, millions of words of text from chats, transcripts, and the like.

There remains a need for systems and methods that utilize a machine learning approach for comprehension of interactions and extraction of data from interactions that does not require pre-set lists of words, phrases, and patterns.

Also previously, training and coaching of customer service agents required human supervision and real-time human input.

There remains a need for systems and methods that utilize a machine learning approach to provide automated coaching enhancement for customer service agent training via a robot (or “bot”) to customer service agents with automated training and/or coaching based on datasets, including training from transcriptions of customer interactions. In addition, there remains a need for systems and methods that provide real-time analytics of a chat between a human agent and a robot “customer,’ for example, to collect datasets that could be used to improve the automated training and provide feedback to the human agent.

Previously, determining the quality and usefulness of human-to-human coaching and human-to-human meeting interactions required human interpretation to decide how well the coaching was performed or the success of a meeting.

There remains a need for systems and methods that provide automated analytics on human-to-human coaching and human-to-human meeting interactions.

### INCORPORATION BY REFERENCE

This application incorporates U.S. Pat. No. 9,413,891 (CALL-0004-U01), issued on Aug. 9, 2016, by reference as an example of analyzing interactions using at least acoustic and language characteristics to generate insights.

### SUMMARY

In an aspect, a procedure may include an operation of obtaining from a plurality of communications, using a processor, a plurality of words and phrases; an operation of applying, using the processor, a word embedding algorithm to the plurality of words and phrases, wherein the word embedding algorithm maps the plurality of words and phrases as vectors in high-dimensional space; an operation of clustering, using the processor, the mapped plurality of words and phrases into a plurality of groups; an operation of applying a constraint to at least one group of the plurality of groups to obtain a modified group; and an operation of determining, using the processor, a category label for the modified group. In addition to determining category labels, root cause for the interaction, insights, and things the interaction participants didn't know may be determined. The procedure may further include mapping a plurality of acoustic characteristics of the plurality of communications in the high-dimensional space. Mapping the plurality of words and phrases as vectors in high-dimensional space may involve using the distances between the vectors.

In an aspect, an interaction summarization system for automatically generating summary output may include one or more processors; and one or more computer readable hardware storage devices having stored computer-executable instructions that are executable by the one or more processors to cause the interaction summarization system to at least: generate a transcript from an interaction including content, the content including at least one of written text, audio speech, non-word symbols, metadata, silences, language characteristics, and acoustic characteristics, and the content being attributed to a participant in the interaction; and generate an interaction summary using a machine learning summarization model that summarizes the content of the interaction. Generating the interaction summary may be based on abstractive summarization of the transcript. Abstractive summarization may be at least one of long form summarization, chunked/bucketed summarization, or an interaction summary label/short sentence.

In an aspect, a procedure for interaction summarization may include an operation of generating a transcript from an interaction including content, the content including at least one of written text, audio speech, non-word symbols, metadata, silences, language characteristics, and acoustic characteristics, and the content being attributed to a participant in the interaction; and an operation of generating an interaction summary using a machine learning summarization model that summarizes the content of the interaction.

In an aspect, a procedure for automatically populating a form may include an operation of selecting a form to populate based on an aspect of an interaction, the form including a structured outline of input fields; an operation of generating a transcript from an interaction including content, the content including at least one of written text, audio speech, non-word symbols, metadata, silences, language characteristics, and acoustic characteristics, and the content being attributed to a participant in the interaction; and an operation of populating the form using a machine learning form filling model that draws information from the transcript of the interaction.

In an aspect, a method may include providing a robotic customer simulation configured with one or more scripted interaction segments, based on an artificial intelligence (AI) system, providing an interactive environment for a training session with a human trainee to respond to a simulated customer interaction with the robotic customer simulation based on the one or more scripted interaction segments, and providing the human trainee, by the robotic customer simulation, with feedback on performance by the human trainee during the training session. In the method, the feedback may include a score of the training session. In the method, the feedback may include suggestions for improvements for optimal outcomes with human customers. In the method, the training session may include at least one of: a new hire evaluation, language competency evaluation, job fit evaluation, role fit evaluation, skill enhancement, concept mastery evaluation, refresher, and/or practice. In the method, the robotic customer simulation may interact with the human trainee using one or both of typed or spoken voice interactions. In the method, the spoken voice interactions may be provided via an interactive voice response (IVR) system. In the method, the robotic customer simulation may provide customer service training to the human trainee in at least one of: handling rote tasks or dealing with difficult or complex situations. In the method, the robotic customer may be associated with another robotic customer simulation, and each of the robotic customer simulation and the another robotic customer simulation may be trained to handle a respective customer service situation.

In an aspect, a system may include one or more processors, and one or more computer-readable hardware storage devices having stored computer-executable instructions that are executable by the one or more processors to cause the system to at least: provide a robotic customer simulation configured with one or more scripted interaction segments, based on an artificial intelligence (AI) system, provide an interactive environment for a training session with a human trainee to respond to a simulated customer interaction with the robotic customer simulation based on the one or more scripted interaction segments, and provide the human trainee, by the robotic customer simulation, with feedback on performance by the human trainee during the training session. In the system, the feedback may include a score of the training session. In the system, the feedback may include suggestions for improvements for optimal outcomes with human customers. In the system, the training session may include at least one of: a new hire evaluation, language competency evaluation, job fit evaluation, role fit evaluation, skill enhancement, concept mastery evaluation, refresher, and/or practice. In the system, the robotic customer simulation may interact with the human trainee using one or both of typed or spoken voice interactions. In the system, the spoken voice interactions may be provided via an interactive voice response (IVR) system. In the system, the robotic customer simulation may provide customer service training to the human trainee in at least one of: handling rote tasks or dealing with difficult or complex situations.

In an aspect, a method includes configuring a robotic customer simulation with one or more scripted interaction segments, the robotic customer simulation executing a machine learning dialogue model, initiating a training session with a human trainee to respond to a simulated customer interaction with the robotic customer simulation based on the one or more scripted interaction segments, wherein the robotic customer simulation is trained to provide a next step in the scripted interaction segment or a conversation point, and generating feedback data, by the robotic customer simulation, on the human trainee's performance during the training session, wherein generating feedback data includes analyzing acoustic and language characteristics of the training session, and determining at least one of a category label or an agent quality score to associate with the training session. The feedback includes a score of the training session or suggestions for improvements for optimal outcomes with human customers. The training session includes at least one of a new hire evaluation, language competency evaluation, job fit evaluation, role fit evaluation, skill enhancement, concept mastery evaluation, refresher, and/or practice. The robotic customer simulation interacts with the human trainee using one or both of typed or spoken voice interactions, wherein the spoken voice interactions are provided via an interactive voice response (IVR) system. The robotic customer simulation provides customer service training to the human trainee in at least one of: handling rote tasks or dealing with difficult or complex situations. The robotic customer simulation is associated with another robotic customer simulation, and each of the robotic customer simulation and the another robotic customer simulation is trained to handle a respective customer service situation.

In an aspect, a system, one or more processors, and one or more computer-readable hardware storage devices having stored computer-executable instructions that are executable by the one or more processors to cause the system to at least configure a robotic customer simulation with one or more scripted interaction segments, the robotic customer simulation executing a machine learning dialogue model, initiate a training session with a human trainee to respond to a simulated customer interaction with the robotic customer simulation based on the one or more scripted interaction segments, wherein the robotic customer simulation is trained to provide a next step in the scripted interaction segment or a conversation point, and generate feedback data, by the robotic customer simulation, on the human trainee's performance during the training session, wherein generating feedback data comprises analyzing acoustic and language characteristics of the training session, and determining at least one of a category label or an agent quality score to associate with the training session. Feedback includes a score of the training session or suggestions for improvements for optimal outcomes with human customers. The training session includes at least one of a new hire evaluation, language competency evaluation, job fit evaluation, role fit evaluation, skill enhancement, concept mastery evaluation, refresher, and/or practice. The robotic customer simulation interacts with the human trainee using one or both of typed or spoken voice interactions. The spoken voice interactions are provided via an interactive voice response (IVR) system. The robotic customer simulation provides customer service training to the human trainee in at least one of handling rote tasks or dealing with difficult or complex situations.

In an aspect, a method may include interacting with a human customer via an automated robotic customer service agent, determining that a human customer service agent is required for the interaction with the human customer, connecting a human customer service agent into the interaction with the human customer, maintaining access to the interaction with the human customer by the automated robotic customer service agent, and assisting, via the automated robotic customer service agent, the human customer service agent in real-time during the interaction with the human customer. The method may further include determining why the human customer service agent was required for the interaction with the human customer. The method may further include feeding back the determination of why the human customer service agent was required to the automated robotic customer service agent, such that the automated robotic customer service agent learns how to resolve the human customer's issues without involving the human customer service agent. In the method, the determining that a human customer service agent is required may include determining at least one of: the automated robotic customer service agent has reached a bot response threshold or the human customer has reached a human response threshold. In the method, the automated robotic customer service agent assisting the human customer service agent in real-time during the interaction with the human customer may include the automated robotic customer service agent communicating directly with only the human customer service agent. In the method, the automated robotic customer service agent assisting the human customer service agent in real-time during the interaction with the human customer may include the automated robotic customer service agent communicating directly with both the human customer service agent and the human customer.

In an aspect, a system may include one or more processors, and one or more computer-readable hardware storage devices having stored computer-executable instructions that are executable by the one or more processors to cause the system to at least: interact with a human customer via an automated robotic customer service agent, determine that a human customer service agent is required for the interaction with the human customer, connect the human customer service agent into the interaction with the human customer, maintain access to the interaction with the human customer by the automated robotic customer service agent, and assist, via the automated robotic customer service agent, the human customer service agent in real-time during the interaction with the human customer. The system may further include instructions to cause the system to determine why the human customer service agent was required for the interaction with the human customer. The system may further include instructions to cause the system to feed back the determination of why the human customer service agent was required to the automated robotic customer service agent, such that the automated robotic customer service agent learns how to resolve the human customer's issues without involving the human customer service agent. In the system, the determining that a human customer service agent is required may include determining at least one of: the automated robotic customer service agent has reached a bot response threshold or the human customer has reached a human response threshold. In the system, the automated robotic customer service agent assisting the human customer service agent in real-time during the interaction with the human customer may include the automated robotic customer service agent communicating directly with only the human customer service agent. In the system, the automated robotic customer service agent assisting the human customer service agent in real-time during the interaction with the human customer may include the automated robotic customer service agent communicating directly with both the human customer service agent and the human customer.

In an aspect, a method may include providing a transcript of an interaction between at least two humans, based on an artificial intelligence (AI) system, analyzing the transcript to determine at least one of a set of insights or a set of behavioral patterns for each of the at least two humans, and generating an interaction score for the interaction, based on the analyzing. In the method, the interaction may include a coaching session. In the method, the interaction may include an online meeting. In the method, the transcript may include at least one of a text chat, a transcription of a spoken voice interaction, or a combination of a text chat and a transcription of a spoken voice interaction. In the method, the analyzing may be performed after the interaction has concluded, concurrently during the interaction, or in real-time during the interaction. In the method, the analyzing may include analyzing the transcript for data corresponding to at least one of: coaching effectiveness behaviors, coaching experiences, employee engagement, or employee wellbeing.

In an aspect, a system may include one or more processors, and one or more computer-readable hardware storage devices having stored computer-executable instructions that are executable by the one or more processors to cause the system to at least: provide a transcript of an interaction between at least two humans, based on an artificial intelligence (AI) system, analyze the transcript to determine at least one of a set of insights or a set of behavioral patterns for each of the at least two humans, and generate an interaction score for the interaction, based on the analyzing. In the system, the interaction may include a coaching session. In the system, the interaction may include an online meeting. In the system, the transcript may include at least one of a text chat, a transcription of a spoken voice interaction, or a combination of a text chat and a transcription of a spoken voice interaction. In the system, the instructions may further cause the system to perform the analyzing after the interaction has concluded, concurrently during the interaction, or in real-time during the interaction. In the system, the analyzing may include analyzing the transcript for data corresponding to at least one of: coaching effectiveness behaviors, coaching experiences, employee engagement, or employee wellbeing.

In an aspect, a computer-implemented method may include (a) obtaining data for a plurality of employees, wherein the data is derived from: (i) at least one of employee scheduling, employee training, employee hierarchies, or workforce management, including information about employee retention (“workforce data”) and (ii) analyzing acoustic and language characteristics of a plurality of communications between customers and the plurality of employees, and determining at least one of a category label or an employee quality score to associate with one or more of the plurality of communications, (b) selecting a training data set from the data to train an artificial intelligence model to determine a likelihood of employee retention, (c) training the artificial intelligence model with the training data set to obtain a trained model, and (d) receiving at least one of a category score, an employee quality score, or a workforce data for an employee and predicting, via the trained model, the likelihood of the employee's retention. Based on the likelihood of the employee's retention, the method may further include delivering at least one positive reinforcement. The method may further include triggering an alert based on the likelihood.

In an aspect, a system may include one or more processors, and one or more computer-readable hardware storage devices having stored computer-executable instructions that are executable by the one or more processors to cause the system to at least (a) obtain data for a plurality of employees, wherein the data is derived from (i) at least one of employee scheduling, employee training, employee hierarchies, or workforce management, including information about employee retention (“workforce data”) and (ii) analyzing acoustic and language characteristics of a plurality of communications between customers and the plurality of employees, and determining at least one of a category label or an employee quality score to associate with one or more of the plurality of communications, (b) select a training data set from the data to train an artificial intelligence model to determine a likelihood of employee retention, (c) train the artificial intelligence model with the training data set to obtain a trained model, and (d) receive at least one of a category score, an employee quality score, or a workforce data for an employee and predicting, via the trained model, the likelihood of the employee's retention. Based on the likelihood of the employee's retention, the processor may be further programmed to deliver at least one positive reinforcement. The processor may be further programmed to trigger an alert based on the likelihood.

In an aspect, a method may include transmitting a recording from an online interaction, including at least one of a text, an audio, or a video data, analyzing at least one of acoustic and language characteristics of a transcript of the recording of an interaction between at least two humans in the online meeting or facial expressions from video data using artificial intelligence recognition, determining, based on the analysis, at least one of a set of insights or a set of behavioral patterns for each of the at least two humans, and generating an interaction score for the interaction. The interaction may include a coaching session or an online meeting. The transcript may include at least one of a text chat, a transcription of a spoken voice interaction, or a combination of a text chat and a transcription of a spoken voice interaction. Analyzing may be performed after the interaction has concluded, concurrently during the interaction, or in real-time during the interaction. Analyzing may include analyzing the transcript for data corresponding to at least one of: coaching effectiveness behaviors, coaching experiences, employee engagement, customer satisfaction or success, product mentions, sentiments, process questions, competitive insights, product level insights, win-loss analysis, or employee wellbeing.

In an aspect, a system may include one or more processors, and one or more computer-readable hardware storage devices having stored computer-executable instructions that are executable by the one or more processors to cause the system to at least transmit a recording from an online interaction to a processor, including at least one of a text, an audio, or a video data, analyze, with the processor, at least one of acoustic and language characteristics of a transcript of the recording of an interaction between at least two humans in the online interaction or facial expressions from video data using artificial intelligence recognition, determine, based on the analysis, at least one of a set of insights or a set of behavioral patterns for each of the at least two humans, and generate an interaction score for the interaction. The interaction may include a coaching session or an online meeting. The transcript may include at least one of a text chat, a transcription of a spoken voice interaction, or a combination of a text chat and a transcription of a spoken voice interaction. The instructions may further cause the system to perform the analyzing after the interaction has concluded, concurrently during the interaction, or in real-time during the interaction. Analyzing may include analyzing the transcript for data corresponding to at least one of: coaching effectiveness behaviors, coaching experiences, employee engagement, customer satisfaction or success, product mentions, sentiments, process questions, competitive insights, product level insights, win-loss analysis, or employee wellbeing.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 depicts a flowchart for clustering.

FIG. 2 depicts a flowchart for clustering.

FIG. 3 depicts a block diagram of an interaction summarization system.

FIG. 4 depicts a flowchart for interaction summarization.

FIG. 5 depicts a flowchart for form filling.

FIG. 6 depicts a screenshot of a graphical user interface for clustering.

FIG. 7 depicts a flowchart of training a call-driver prediction model.

FIG. 8 depicts a flowchart of a method for automated coaching enhancement via robotic training.

FIG. 9 depicts a flowchart of the method for automated coaching enhancement via robotic training.

FIG. 10 depicts a block diagram of a system for automated coaching enhancement via robotic training.

FIG. 11 depicts a block diagram of the system for automated coaching enhancement via robotic training.

FIG. 12 depicts a block diagram of the system for automated coaching enhancement via robotic training.

FIG. 13 depicts a flowchart of a method for robotic customer service agent assistance.

FIG. 14 depicts a flowchart of the method for robotic customer service agent assistance.

FIG. 15 depicts a flowchart of the method for robotic customer service agent assistance.

FIG. 16 depicts a block diagram of a system for robotic customer service agent assistance.

FIG. 17 depicts a block diagram of the system for robotic customer service agent assistance.

FIG. 18 depicts a flowchart of a method for automated coaching enhancement via robotic training.

FIG. 19 depicts a flowchart of the method for automated coaching enhancement via robotic training.

FIG. 20 depicts a block diagram of a system for automated coaching enhancement via robotic training.

FIG. 21 depicts a block diagram of the system for automated coaching enhancement via robotic training.

FIG. 22 depicts descriptions of a coaching environment.

FIG. 23 depicts a flowchart of a method for predictive retention.

FIG. 24 depicts a flowchart of a method for generating an interaction score.

FIG. 25 depicts the timeline of the output display of topics.

FIG. 26 depicts a block diagram of a categorization system.

FIG. 27 depicts a flowchart for automatically populating a form using a supervised learning model.

FIG. 28 depicts a flowchart for automatically populating a form using a unsupervised learning model.

FIG. 29 depicts a block diagram of a system for a robotic customer simulation.

FIG. 30 depicts a block diagram of a coaching system.

FIG. 31 depicts a block diagram of a categorization system.

FIG. 32 depicts a flowchart of a procedure for topic identification.

FIG. 33 depicts a flowchart of a procedure for call-driver prediction.

FIG. 34 depicts a flowchart of a procedure for predicting employee retention.

FIG. 35 depicts a flowchart of a procedure for predicting employee retention.

FIG. 36 depicts a block diagram of a system for predicting employee retention.

FIG. 37 depicts a block diagram of a coaching system.

FIG. 38 depicts a flowchart of a procedure for topic identification.

### DETAILED DESCRIPTION

The present disclosure describes systems and methods utilizing machine learning tools to extract, abstract, and synthesize information from interactions from multiple channels, such as phone calls, chats, messaging, blog posts, social media posts, surveys, Interactive Voice Response (IVR), e-mails, video conferences, online meetings, webinars, and the like, occurring in real-time, near-real-time or historical. Machine learning tools enable automated interaction summarization, automated form filling, automated categorization through a search of high dimensional space, and the like. Such improvements enable increased support for individuals involved in live conversational support functions (e.g., enterprise customer support call center employees), time savings from automation of post-interaction tasks, increased compliance based on in-progress monitoring for compliance-related data, enhanced insights from interactions across an enterprise, increased customer satisfaction, and the like. Also disclosed herein are methods and systems for identifying temporal changes in the frequency of a topic in a set of interactions.

Categorization is a component of interaction analytics that involves the labelling or tagging of communications and/or communication portions that contain certain language patterns, keywords, phrases, acoustic features, non-word symbols, or other characteristics with one or more relevant categories. Categorization is the task when a system is provided with input data, which could be a word or a phrase, a transcribed speech, an emotion, non-word symbols, acoustic features, or any part of a communication, and the system can assign a category to the communication. Therefore, categorization facilitates analysis. In some cases, the category is for one or more of a plurality of communications involving an employee and one or more participants. Categorization has previously leveraged pre-set lists of language patterns, keywords, phrases, acoustic features, non-word symbols, or other characteristics of a communication in association with particular categories such that when the item appears in a communication, the category may be applied. Previously, creating new categories involved simple pattern recognition and identifying similarities and differences in communications. However, communication is dynamic, and having a pre-populated list of language patterns may not be adequate (e.g., not robust). There is a need for categorization in systems where pre-populated lists are not available, and that may be more robust than pattern recognition.

In an aspect, a categorization system is disclosed herein. Clustering words and phrases of an interaction, using the categorization system, may leverage machine learning to learn the relationships of phrases and words in order to generate categories de novo.

Category creation may be based on a guided search of high dimensional space/graphed words with a graph and word embedding algorithm that generates searchable, interrogatable data whose answers are intended to provide additional context and may generate insights, cause discovery of unexpected correlations, and cause isolation of vectors not typically realized by a human user, wherein the process involves iteration to inform subsequent iterations.

Consequently, in this way, all entities need not use the same pre-set lists of categories; rather, categories can be customized for sets of interactions, such as communications involving a particular entity/enterprise. Also described later herein is a linguistic annotation method that facilitates search and categorization by adding a layer of grammatical structure.

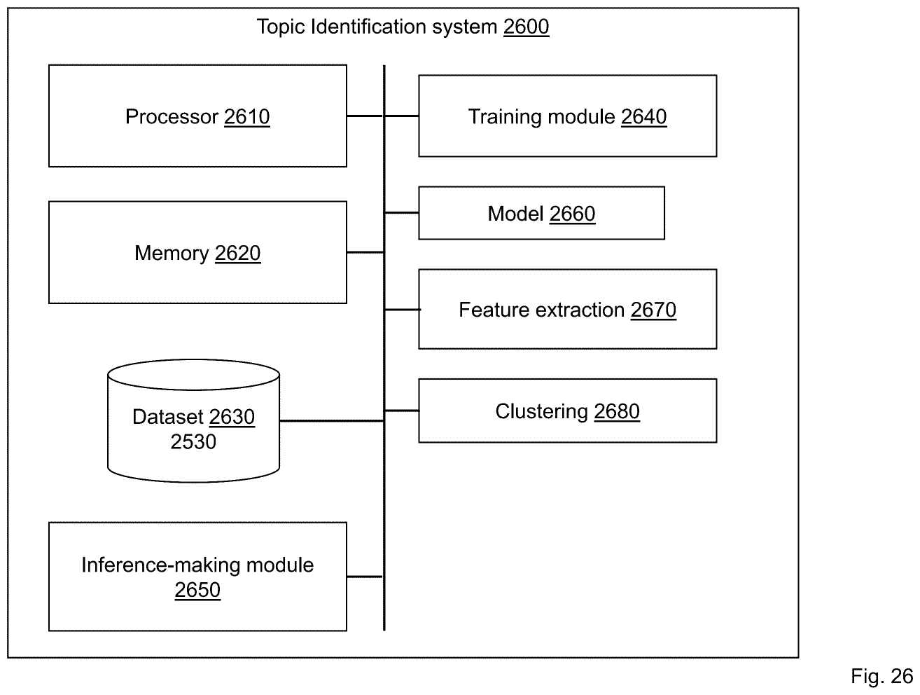

In an aspect, a single entity or enterprise's communications and interactions may be harvested for words resulting in a large set of words. For example, the set of words may number greater than 40 million words. First, the categorization system may graph the words or phrases in high dimensional space, which may in embodiments involve using the feature extraction 2670 (with reference to FIG. 26), giving individual words or phrases a plurality of dimensions, such as for example, 300 dimensions. Using a word embedding algorithm, the categorization system may determine which words or phrases exist near each other in high dimensional space without regard, for example, to where they exist near each other in a transcript, or having to describe the actual meaning of any words. Word embeddings (also known as word representations), transform words or phrases (data) into a high dimensional space where related words are closer to each other. Word embedding may be pre-trained to assign dimensions to particular words so that each word or phrase represents a data point in high dimensional space. For example, synonym words will be close in high dimensional space. By evaluating the plurality of dimensions, the system may place related words closer together in high-dimensional space. Strictly speaking, word embedding handles words only and determines the word's embedding within a sentence. A phrase, which is usually more than one word, may require some processing to make it one word (e.g., hello world can be hello_world) or processes the output of word embedding of each word, etc. For the purpose of this application, the term word embedding is used to determine the embedding of a word, a phrase, or a sentence, and the like. There are several methods that perform word embedding, such as, and without limitation, Word2Vec, developed by Google™ (Mikolov, Tomas, et al. “Efficient estimation of word representations in vector space.” arXiv preprint arXiv:1301.3781 (2013)), incorporated herein by reference, GloVe, (Pennington, Jeffrey, Richard Socher, and Christopher D. Manning. “Glove: Global vectors for word representation.” Proceedings of the 2014 conference on empirical methods in natural language processing (EMNLP). 2014), incorporated herein by reference, or BERT (Devlin, Jacob, et al. “Bert: Pre-training of deep bidirectional transformers for language understanding.” arXiv preprint arXiv:1810.04805 (2018)), incorporated herein by reference) and the many variations. Some of the aforementioned methods, such as BERT, are capable of handling sentences. For instance, phrases with similar contexts are closer to each other in high dimensional space than phrases with different contexts.

The word embedding algorithm can then be used to explore the graph to cluster words. For example, ‘front door’, ‘back door’, ‘side door’, ‘on the steps’, ‘delivery’, ‘FedEx’, and ‘UPS’ may be clustered by the algorithm which determines that a ‘delivery conversation’ is in these set of words. In another example, a user can type in a keyword (e.g., pillow) and the categorization system may surface clusters related to the keyword, such as colors of pillows from all interactions, all the ways pillows are talked about, etc. The user may continue exploring the graph based on adding words to the query or some other constraint, such as after a suggestion from the system, which results in moving around the graph and obtaining a modified group of clustered words. Therefore, the user may be taken further and further away from the word ‘pillow’ as they move through the categories. This is because the phrases, based on the added constraints (also referred to as context), can be closer, in high dimensional space, to another word or phrase in another category. For instance, “pillow,” along with additional context (constraints), may potentially be related to items in the results set, such as couches, chairs, end tables, dressers, and ottomans. Thus, adding constraints resembles traversal through a graph; the ‘pillow’ input data (interchangeably referred to as query) led the user to several bespoke categorizations with each evolution of the query without reliance on any pre-set notions of category.

Since word embedding depends on context, then a slight change in the data contact may change the extracted feature. For example, features extracted for “delivery status” would be different from the features of “delivery damaged,” even though both are two words and related to delivery, but they likely belong in different clusters. In the grand scheme of things, “delivery status” and “delivery damaged” may still be closer to each other when compared to, for example, “dog barking;” however, for an e-commerce business, for example, “delivery status” and “delivery damaged” may belong in different categories.

Therefore, even if “delivery” by itself would go to a specific category, adding context would traverse through categories, which is a benefit of using the categorization system. This aforementioned example of how a change in context could change categorization could be looked at as creating a category.

In some embodiments, the query itself may be auto-generated. For example, a sentence of interest may be identified (e.g., “At a particular moment in a call, the customers typically get friendlier”). Based on this sentence, the categorization system may auto-generate a query in a query syntax (e.g., “moment” NEAR “in a call”) and the search string may be searched in available communications and interactions. In embodiments, the area around the search results may be compared to an area where it is known that the sentence of interest exists to determine false positives or false negatives. Based on the results of this analysis, the categorization system may further refine the query. In other words, the categories of similar data may be suggested to the user, and the user may determine if those categories are desirable for the task of communication and interaction. If approved, then the generated category is used for the sentence of interest; otherwise, another query syntax is generated.

In embodiments, the categorization system or machine learning model may be used to discover similar communication drivers given an identified call driver. A call driver may simply be the reason for a call (e.g., “phone activation” could be the call driver for “I want to activate my phone”). Like the similar words generated by the categorization system, similar sentences can be generated based on a previously determined category. One way to do this is to generate word embedding, such as by the feature extraction 2670, in real-time and find the most similar sentences. This takes a long time because of word embedding generation and clustering. A shortcut for achieving a similar result is to use the call driver clusters, find the center for each cluster (e.g., a centroid of a cluster), and use that center embedding to find the most similar clusters.

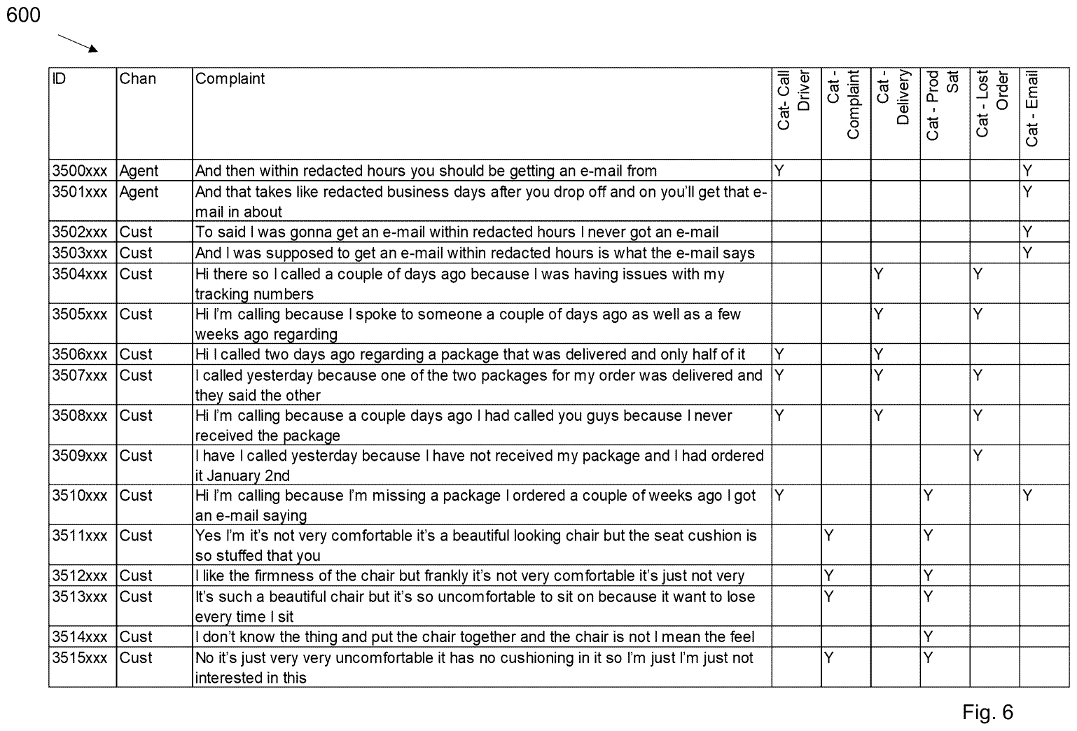

Call driver clusters could be the average of all embeddings in each cluster. This is done by: 1) determining the center of each cluster by finding the average of all dimensions for all embeddings in a cluster; and 2) for each center embedding, determining a list of clusters with similar center embeddings, in order from most similar to most different, based on a similarity measure (e.g., the nearest distance in high dimensional space). For example, and referring to FIG. 6, three clusters are shown in a table form 600; the first four lines belong to one cluster, the next seven lines are another cluster, and the last five lines are a third cluster. Each line corresponds to a portion of an interaction, in this case, broadly categorized as a complaint. Each complaint is designated by an ID and attributed to a particular user. Each complaint is categorized as shown in the columns on the right. The categories shown in FIG. 6 include, for example, call driver, complaint, delivery, product satisfaction, lost order, and email. However, it should be understood that any possible topic may be used to categorize items in a cluster. In this case, for example, the last five lines all are assigned the product satisfaction category and 4 of 5 of the lines are assigned the complaint category. On this basis, these 5 lines are considered a cluster. Similarly, the first four lines are all assigned the email category, so they are considered a cluster. The label of a cluster and corresponding category is based on the distance in high dimensional space from the centroid of that cluster.

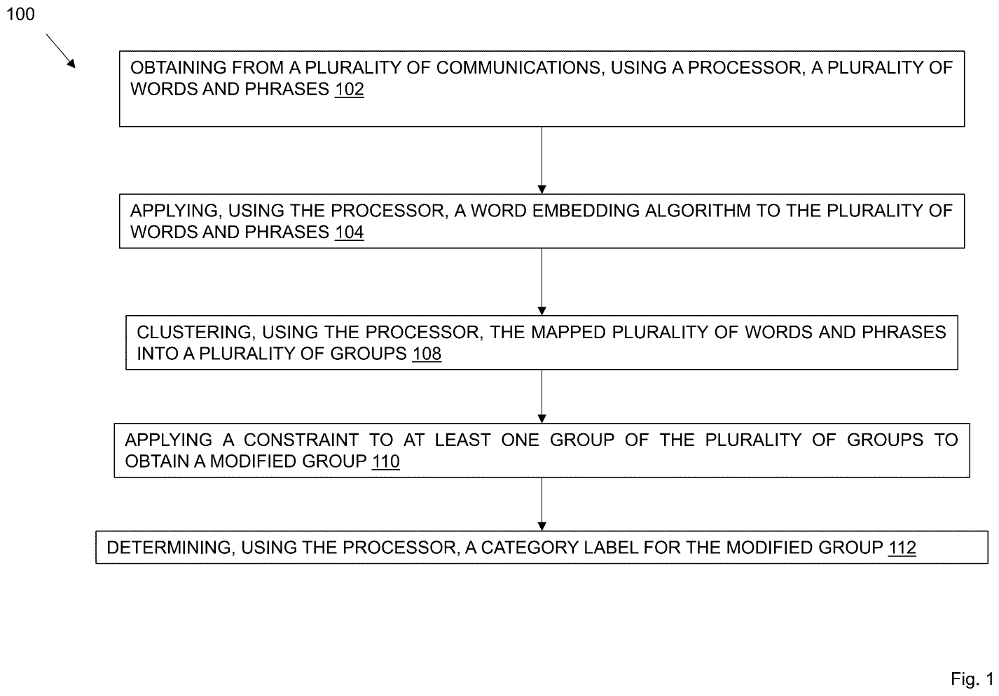

In an embodiment, and referring to FIG. 1, a procedure 100 may include operations such as an operation 102 of obtaining from a plurality of communications, using a processor, a plurality of words and phrases; an operation 104 of applying, using the processor, a word embedding algorithm to the plurality of words and phrases. The word embedding algorithm may map the plurality of words and phrases as vectors in high-dimensional space. The procedure 100 may further include an operation 108 of clustering, using the processor, the mapped plurality of words and phrases into a plurality of groups; an operation 110 of applying a constraint to at least one group of the plurality of groups to obtain a modified group; and an operation 112 of determining, using the processor, a category label for the modified group. The constraint may be at least one of a keyword, a phrase, or groupings of words in phrases that are in close proximity. In addition to determining category labels, such as for nodes or clusters in the graph, root cause for the interaction, insights, and things the interaction participants didn't know may be determined. Mapping the plurality of words and phrases as vectors in high-dimensional space may involve using the distances between the vectors.

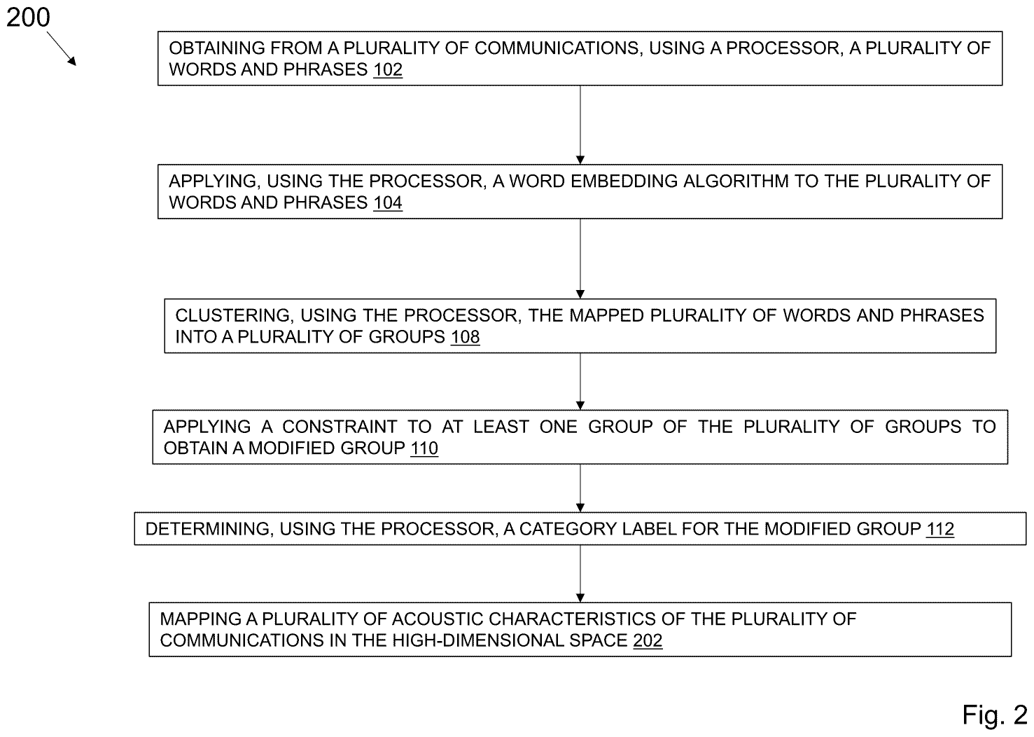

Referring to FIG. 2, the procedure 200 may further include an operation 202 of mapping a plurality of acoustic characteristics of the plurality of communications in the high-dimensional space. Anything that can be embedded can be graphed, such as acoustic characteristics.

For example, a word may be assigned a series of binary numbers to represent each letter. In an example, if the word is “Hello”, the binary of that may be 0110100001100101 01101100 01101100 0110111, which may be plotted as a number with a distance from zero that is the location in high dimensional space. Continuing with the example, the acoustic characteristics of the word “Hello” such as when uttered in an interaction, may include at least one of a speed, (e.g., 0.25 per second), a volume (e.g., 0.7 above the baseline), or a gain (e.g., 1 deviation). Each acoustic characteristic may be assigned a binary representation, such as for example, 11011111001110000101001. The binary representation of the word and the binary representation of the word's acoustic characteristics may have no relationship. However, the two representations may be combined to obtain a new binary representation for the combination, such as in this example, 0110100001100101 01101100 01101100 011011111011111001110000101001. By obtaining combined representations, such as in binary, hexadecimal, or any other appropriate coordinates, data of different types may be graphed together in high dimensional space, with the relationship between words being constrained by the combined dimensions. Similar to elsewhere described herein, any number that is very close is similar, and the further away one representation is from another, the more they are dissimilar.

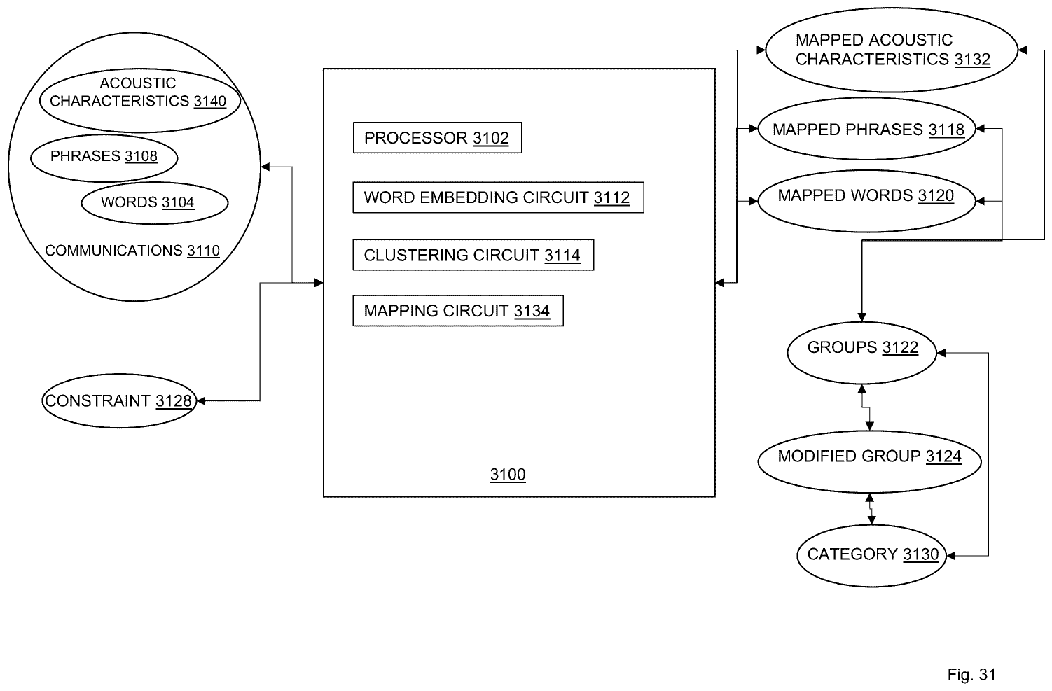

Referring now to FIG. 31, a system 3100 may include a processor 3102 programmed to obtain a plurality of words 3104 and phrases 3108 from a plurality of communications 3110. The system 3100 may also include a word embedding circuit 3112 programmed to map the plurality of words and phrases as vectors in high-dimensional space with distances between the vectors based on dimensions assigned to the plurality of words 3104 and phrases 3108. The system 3100 may also include a clustering circuit 3114 programmed to cluster the mapped plurality of words 3120 and phrases 3118 into a plurality of groups 3122 using the vector distances. The processor 3102 may be further programmed to apply a constraint 3128 to at least one group of the plurality of groups 3122 to obtain at least one modified group 3124, wherein the constraint 3128 is at least one of a keyword, a phrase, or groupings of words in phrases which are in close proximity. The processor 3102 is also further programmed to determine a category 3130 for the at least one modified group 3124. The system 3100 may also include a mapping circuit 3134 programmed to map a plurality of acoustic characteristics 3140 of the plurality of communications 3110 in the high-dimensional space as one or more vectors. The clustering circuit 3114 may be further programmed to cluster the mapped plurality of words 3120 and phrases 3118 and the mapped plurality of acoustic characteristics 3132 into a plurality of groups 3122 using the vector distances. In embodiments, applying the constraint 3128 may involve finding close vectors using the vector distances. In embodiments, the category 3130 may be utilized in performing an analysis of agent performance. The one or more vectors may be a real-valued vector encoding for each word 3104 or phrase 3108 of the plurality of communications 3110. In embodiments, applying the constraint 3128 may enable traversing through the plurality of groups 3122, wherein each group of the plurality of groups 3122 has a category 3130.

In an embodiment, call driver prediction of an interaction or communication may be performed using models to determine if a sentence/phrase/word is call-driver or not. While it may not be possible to find all the possible reasons why customers called, a reasonable distribution of all the top-ranked reasons should be attainable.

Determining the call driver of an interaction could be performed utilizing a machine learning algorithm. Example embodiments use supervised learning, for which a labeled dataset is provided. During the training stage of which, phrases of interactions are labeled, and a call driver model is generated. For instance, in step 1, all phrases in previous communications and interactions are reviewed. In example embodiments, the communications and interactions are reviewed in chronological order. Phrases that are call-drivers are labeled 1, and the others are labeled 0. This numbering is arbitrary—any label could be given. It is just desired to formulate the labels as having two categories—call drivers and not call drivers.

In example embodiments, labeling may be performed by human intervention. In other example embodiments, the labels may be assigned by a previously trained call driver model. In example embodiments, a call-driver model may perform the first run in labeling data and humans confirm decisions. Ideally, a small set, such as 100 call-driver sentences, is used to train in the first round. In Step 2, a model is trained using all the data in the labeled dataset. This generates the call-driver model. The training could use supervised learning methods such as support vector machines, neural networks, and the like. The supervised learning method task is to generate a model that could discriminate between embeddings having a label of 1 from embeddings having a label of 0. Unsupervised learning may also be used, such as clustering to cluster and segment the dataset into two clusters, one cluster having embeddings of call-drivers and the other having clusters for not call-drivers. In unsupervised learning, more than two clusters may also be used. A group of clusters could be for call-drivers and another group could be for not call-drivers. Example embodiments may have both supervised and unsupervised models—e.g., an unsupervised model that performs clustering first, then a subsequent supervised model to confirm the result. A semi-supervised model may be used as well, where some dataset examples are labeled while others are not.

In Step 3, the model is tested (evaluated) by predicting unlabeled data to provide feedback and increase the amount of labeled data. When run on unlabeled data, data (examples) of the dataset that were predicted as 1 (which represents call-driver by the model) are annotated. This may save time because it should have a higher percentage of the sentences actually being call-driver. Then, the newly annotated data are combined with the data that were labeled before. The annotation may also be done by third party software/workforce, client analysts, or other humans. This annotation provides feedback and measures the error that the training method (e.g., the supervised training method such as neural networks) try to minimize. In Step 4, Steps 2-3 are repeated until a model with acceptable error (e.g., Fi (>0.80)) is achieved. The F-score is a machine learning metric that can be used in classification models; it is a measure of a test's accuracy and is a harmonic mean of precision. The generated call driver model can then be deployed using any known or yet-to-be-known framework coupled with routine monitoring to be used for inference-making to identify call driver phrases from input data received by a system (e.g., categorization system). During inference making, the driver call model is executed by the following: Step 1, receiving input data; Step 2, splitting input data into phrases and generating the word embedding of each; Step 3, applying the model on the input data and receiving the output of the model. Step 4, providing the output to the user.

In embodiments, call driver prediction may be trained on enterprise-specific data so that the model is tuned to the sorts of topics and language used in interactions with the enterprise. In embodiments, identified call drivers in a data set may be clustered to rank the most important ones.

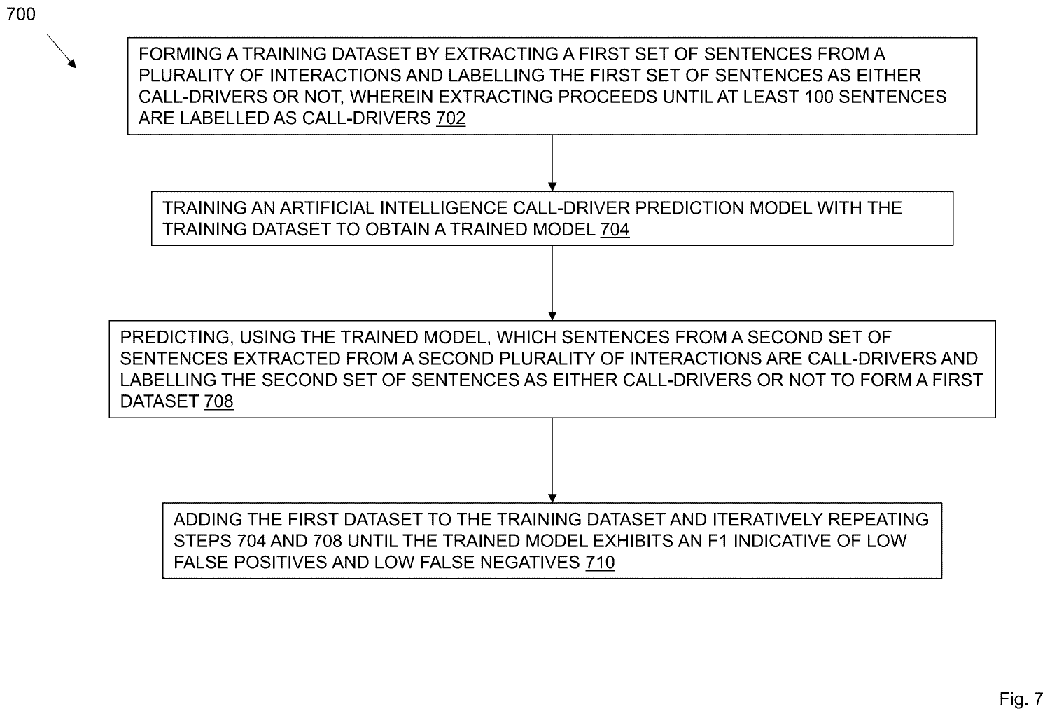

In an embodiment and referring to FIG. 7, a computer-implemented method 700 may include a step 702 of forming a training dataset by extracting a first set of sentences from a plurality of interactions and labeling the first set of sentences with one of two labels—either call-drivers or not, the first label representing call-drivers and the second label representing not call-drivers. Extracting proceeds until at least 100 sentences are labeled as call-drivers. The method 700 also includes a step 704 of training an artificial intelligence call-driver prediction model (aka call-driver model) with the training dataset to classify sentences with the first label or the second label, thereby obtaining a trained model. The method 700 may also include a step 708 of predicting, using the trained call-driver model, which sentences from a second set of sentences extracted from a second plurality of interactions are call-drivers and labeling the second set of sentences as either call-drivers or not, i.e., with one of the first label or the second label, to form a dataset; and a step 710 of adding the dataset to the training dataset and iteratively repeating steps 704 and 708 until a training error value is achieved. The training error value may be an Fi indicative of low false positives and low false negatives. The extracted sentences may be reviewed and labeled in chronological order. Training may further include first stratifying the training dataset to avoid sampling bias and/or duplication.

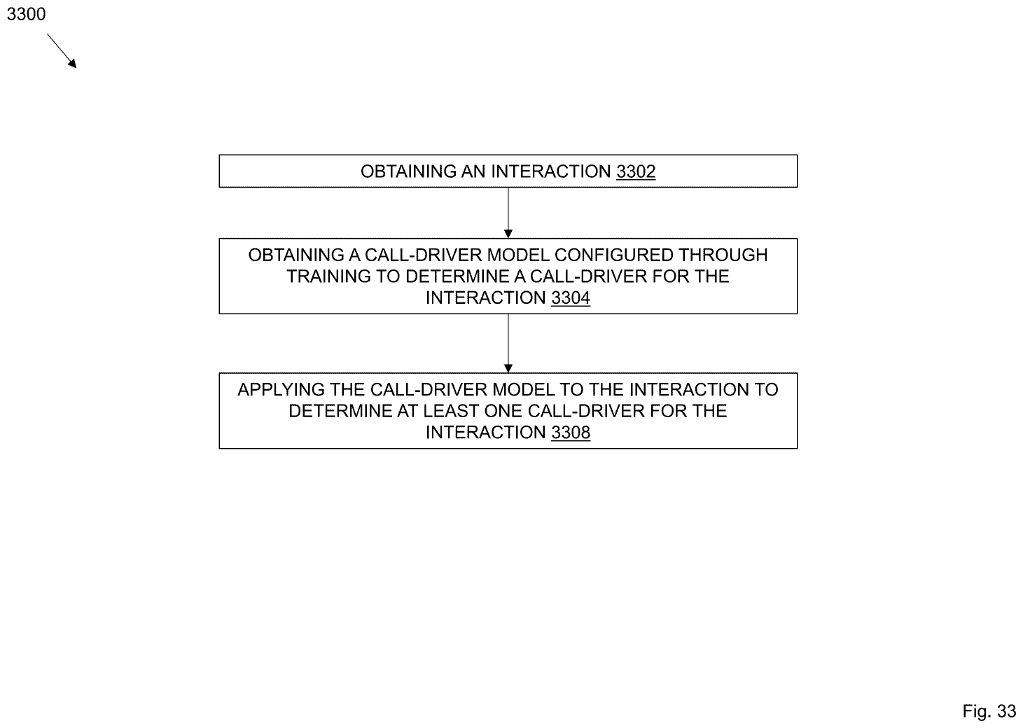

Referring to FIG. 33, a procedure 3300 for predicting a call-driver may include an operation 3302 of obtaining an interaction, an operation 3304 of obtaining a call-driver model configured through training to determine a call-driver for the interaction, and an operation 3308 of applying the call-driver model to the interaction to determine at least one call-driver for the interaction.

In an embodiment, a linguistic annotation algorithm may be used to improve clustering and search. The linguistic annotation algorithm may be used to do dependency parsing on the interaction data to result in relationship-oriented language building (e.g., determining the relationship between an adjective and a noun in the sentence). Identified dependencies can then be queried. For example, the parts of speech, and their dependency on one another in a typical interaction, can be used to build a new query, such as “verb BEFORE:4 noun NOTNEAR:0 (blue))”, which searches for a verb occurring 4 seconds before the start time of a noun, so long as it does not overlap with the word ‘blue’.

In example embodiments, interaction summaries are determined. Interaction summaries may be generated for interactions received by an interaction summarization system. The interaction summarization system facilitates taking action based on one or more events that occurred or are occurring during the interaction. For example, as an interaction is in progress, summary information may be extracted and presented to a user allowing the user to review the contents of the interaction and address any outstanding issues before terminating the interaction. In another example, interaction summaries may facilitate follow-up on a customer concern. Interaction summaries may also be used by other users/agents taking the call and attending to a matter. Those agents/users are different from the ones who had the interaction with the customer. Instead of repeating or reading all the notes of the previous agent, the interaction summary may be summarized, hence, saving a substantial amount of time.

When approaching automatic text summarization to generate an interaction summary, there are at least two different types that may be employed: abstractive and extractive. In general, extractive text summarization utilizes the raw structures, sentences, or phrases of the text and outputs a summarization, leveraging only the content from the source material while abstractive summarization utilizes vocabularies that go beyond the content. Both approaches are contemplated with respect to interaction summaries disclosed herein.

Described herein is an interaction summarization system, which may be a direct API path/functionality to generate an interaction summary including data accumulated, ingested, extracted, and abstracted during the interaction, such as categories, scores, typed notes, checkboxes, and the like. The application may include a facility for a user to format the summary, including normalizing and translating fields for export, such as export to a CRM/ERP ticket system. The facility may also be used to customize the summary or incorporate user preferences in summary generation. The approach may take advantage of machine learning or pattern recognition in the summarization approach.

In embodiments, interaction summarization may utilize models trained at the client level. While producing a specialized result, the cost of this approach may be high, so a generalized approach to interaction summarization is needed. In an embodiment, a transformer-based approach utilizing a pretrained model may be tuned to the contact center environment and may provide several levels of summarization. It should be understood that models may be tuned to any relevant environment, such as by using a training dataset aligned with the environment. The approach may leverage a combination of abstractive and extractive summarization. For example, a pre-trained model useful in the interaction summarization system may be a human-annotated dataset trained on abstractive dialogue summaries. The pre-trained, meeting summarization model may be used to process ongoing interactions or transcripts of interactions. In either case, dialogue turns may be used to facilitate summarization.

For example, extractive summarization, a supervised method, similar to the one applied for call driver prediction may be used. It is a binary classification problem in the sense that the training data is labeled with 0 and 1. One of the labels indicates that the phrase is part of the summary and the other indicates that the phrase is not part of the summary. The dataset could be annotated by humans or another model or software. A similar process as described above for the call driver prediction may be applied here, but instead of call driver phrases, the words or phrases would be in the summary. It is worth mentioning that this classification could be based on a base model that is fine-tuned, such as the BERT model mentioned herein for word embedding (Devlin, Jacob, et al. “Bert: Pre-training of deep bidirectional transformers for language understanding.” arXiv preprint arXiv:1810.04805 (2018)). The base model is applied to an annotated dataset with desired labels and the model is fine-tuned to generate the desired output, sometimes with the assistance of a subsequent classifier. In embodiments, the output of the interaction summarization system may take multiple forms. At base, the output summary may be short, include important pieces of information and an indication of a speaker, and in embodiments, be presented in the third person. For example, one output may be long form summarization. Depending on the interaction length, the summary may be one to several paragraphs about the interaction. Long form summarization may be a feature rich tool that can be used to group interactions or inform models. In another example, an output of the interaction summarization system may be chunked or bucketed summarization. In this example, short summaries of targeted location in the interaction may be generated, such as reason for call or resolution. Chunked summarization allows topic and contact clustering, as well as targeted identification of things like root causes, after call work, and notes. In yet another example, an output of the interaction summarization system may be an interaction summary label, or short sentence that captures what the interaction is about and what happened. Labels may allow for disposition and notes on interactions, plus macro trending in the organization. In embodiments, users may select the granularity of the summary such as by increasing an amount of text ingested, or changing the desired sentence length for the summary. In an embodiment, the transformer architecture of the summarization model may include an autoencoder that is divided into encoder and decoder. The encoder may receive the transcript and generate encodings, and the decoder may receive the encodings and generate the summary.

For example, an actual exchange during an interaction may be the following: “Agent: Good afternoon, thanks for calling the Bank of Jeff today. How can I help?Customer: Hi there, yes, I'd like to have some more information about your mortgage rate please. Agent: Uh, yeah, that should be something I can help out with on the phone this afternoon. And do you already have an account with us? Customer: Yes, I do, yes. Agent: Right in that case, can I start off by taking your full name, please? Customer: Yeah, that's Miss Patricia Wainwright. Agent: OK, thanks for that and also your National Insurance number please. Customer: Yep, and that's Ty 380112 C. Agent: Right and last but not least your birthdate please. Customer: Yep, that's the 12th of the 7th 1994. Agent: OK, so all through security then it's gonna bring up your account onto my screen and whilst it's doing that what is that? What kind of what is it? Information wise you're looking for today? Customer: Well, basically the situation is I want to get a mortgage. I'd be looking on your website . . . .” In one example, the abstractive summary of that exchange generated by the interaction summarization system may be: “Customer wants to get a mortgage for £80,000, but the interest rates for that amount are too high. Agent will help him with that this afternoon. Customer's full name is Patricia Wainwright, her National Insurance number is 380112 C, and her birth date is 12th of the 7th of January 1994. Customer is looking for a 20-year mortgage on a gold package. The interest rate is 31.5%, but there is an 85% discount for members of the bank. Agent will send the information to the customer via e-mail. The information is also available on the Bank of Jeff s website. ˜ The agent will send a summary of the conversation to the new mortgage customer at http://google.com in case it hasn't arrived yet. He will be sending it in the next 15 minutes. The agent has answered all of the customer's questions and he doesn't have any more.”

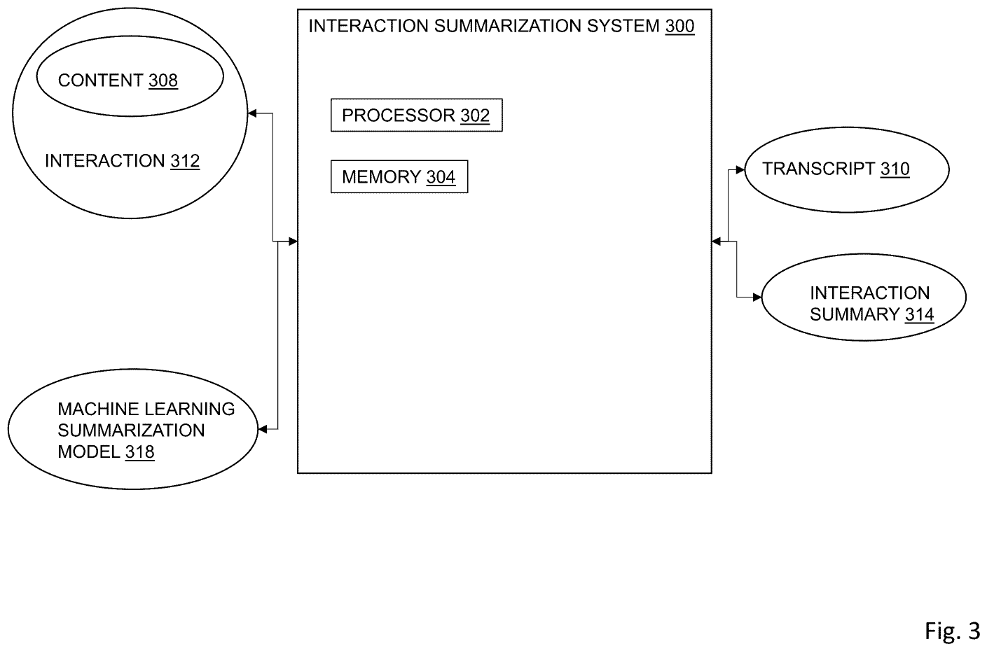

In an embodiment, and referring to FIG. 3, an interaction summarization system 300 for automatically generating summary output may include one or more processors 302 and one or more computer-readable hardware storage devices, or memory 304, having stored computer-executable instructions that are executable by the one or more processors 302 to cause the interaction summarization system 300 to at least generate a transcript 310 from an interaction 312 including content 308, the content 308 including at least one of written text, audio speech, non-word symbols, metadata, silences, language characteristics, and acoustic characteristics, and the content being attributed to a participant in the interaction, and generate an interaction summary 314 using a machine learning summarization model 318 that summarizes the content of the interaction. The machine learning summarization model 318 may be an extractive machine learning summarization model or an abstractive machine learning summarization model that summarizes the content of the interaction. Generating the interaction summary 314 may be based on abstractive summarization of the transcript 310. The abstractive summarization may be at least one of long form summarization, chunked/bucketed summarization, or an interaction summary label/short sentence. The extractive machine learning summarization model may be configured through training to identify at least one word or phrase from the content, the at least one word or phrase corresponding to the summary output of the interaction. The training may be based on supervised learning for two-class labels, a first label being for summary content and a second label being for non-summary content.

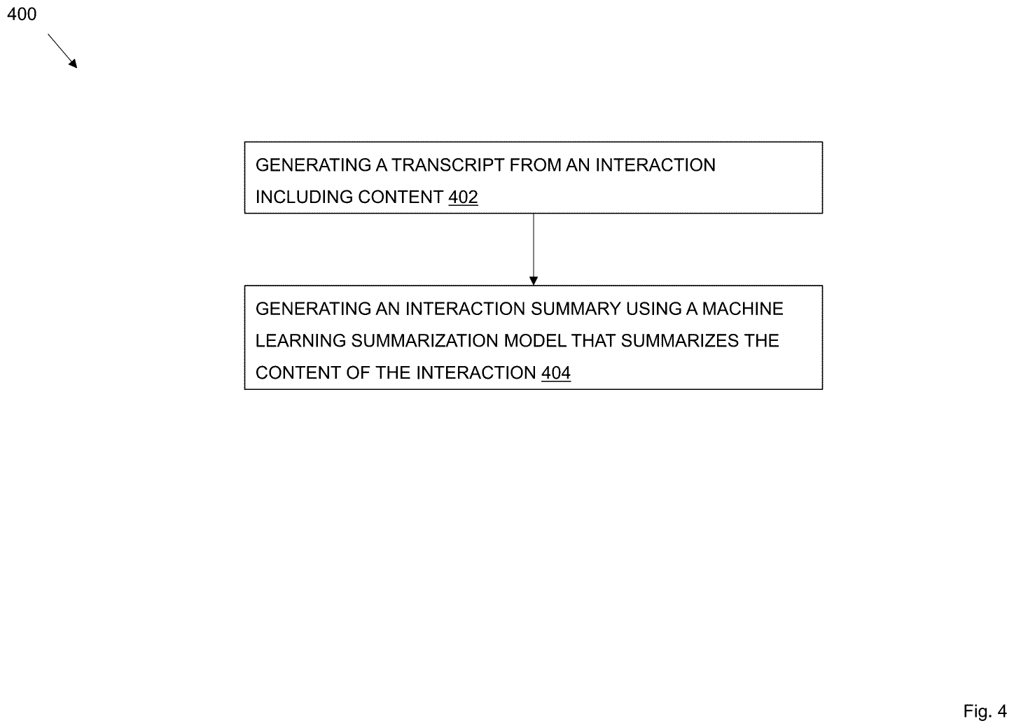

In an embodiment, and referring to FIG. 4, a procedure 400 for interaction summarization may include an operation 402 of generating a transcript from an interaction including content. The content may include at least one of written text, audio speech, non-word symbols, metadata, silences, language characteristics, and acoustic characteristics, and the content may be attributed to a participant in the interaction. The procedure 400 may also include an operation 404 of generating an interaction summary using a machine learning summarization model that summarizes the content of the interaction.

In another embodiment, if the interaction requires an interaction form to be completed or other templates to be populated, the interaction summarization system may populate the forms/templates, such as compliance or complaint forms. In embodiments, the template may include a structured outline of input fields associated with a particular interaction type. In embodiments, when the system identifies an interaction type, one or more relevant templates may be identified and populated. For example, when an interaction is determined to involve activation of a new cell phone, a particular form with pre-set information fields may be selected by the interaction summarization system to be populated based on information extracted and/or abstracted from the interaction by the interaction summarization system. In some embodiments, a user may select the form themselves for population by the interaction summarization system. In some embodiments, a user may pre-select a form to be populated during an interaction and the user can monitor progression of the form's auto-population during the interaction.

In embodiments, the interaction summarization system may employ a machine learning form-filling model, such as a Q&A model, that may be trained on datasets including Q&A dialogues and accompanying filled forms. Filling out forms by humans could be prone to errors and time consuming, especially when the number of fields desired in a summary is large and the number of summaries to be completed is large. This type of system could also be referred to as filling categorical fields. It primarily matches questions with identified responses in the received input (interaction). In embodiments, the Q&A model may be an NLP (natural language processing) model. In embodiments, the Q&A model may be trained on a dataset and then refined on a different dataset, such as a proprietary dataset, to fine-tune the model to the way that questions and answers occur within a call center environment.

The form may have a field with a question, “Was the agent empathetic?” and the Q&A trained model may process the interaction to determine an appropriate response with which to populate the answer field in the form.

In example embodiments, the dataset may include filled forms having both the questions and respective answers. Each question may have a model trained to identify possible answers from the dataset. This question and answer may be represented by respective word embedding. During inference-making, the input data (e.g., the interaction) may be split up and the sentence/phrase/word embedding may be determined. Each question's model could be applied to the word embeddings of the interaction to determine the most suitable response. In another example, one model may be used for all questions in the form. For instance, a clustering method could be used such that one or more clusters belong to each question, determined from the training dataset. During inference-making, a similarity measure is used to check which cluster each part of the interaction's word embeddings belongs in. The aforementioned are two embodiments, one for supervised learning and another for unsupervised learning illustrating how forms can be filled out using machine learning.

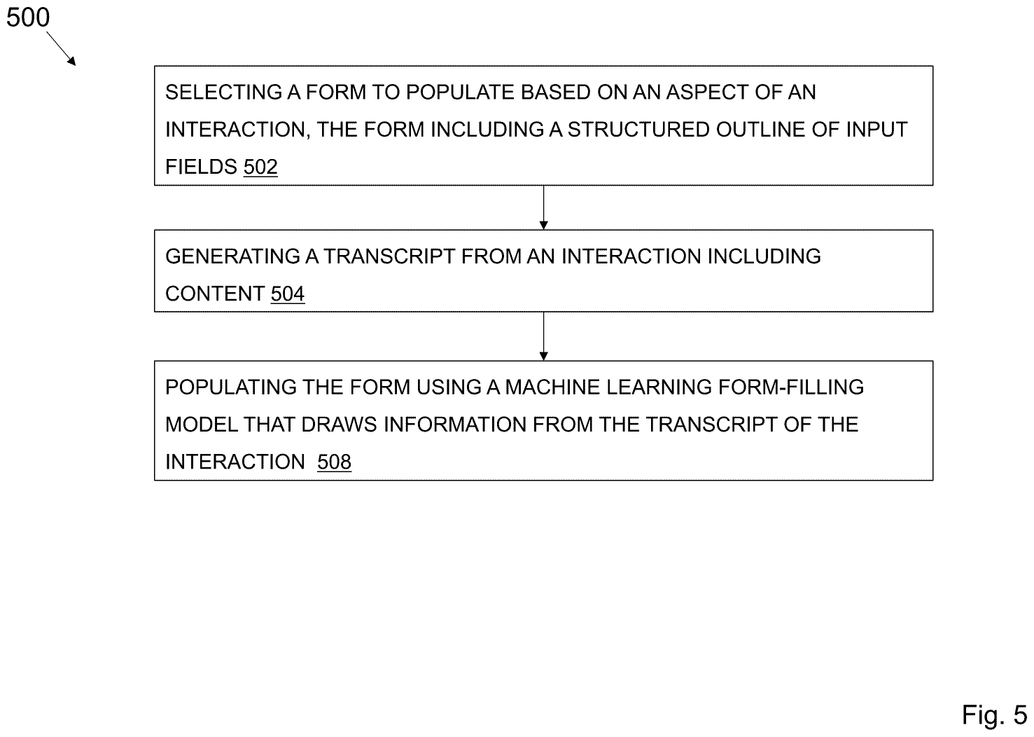

In an embodiment, and referring to FIG. 5, a procedure 500 for automatically populating a form may include an operation 502 of selecting a form to populate based on an aspect of an interaction, the form including a structured outline of input fields; and an operation 504 of generating a transcript from an interaction including content. The content may include at least one of written text, audio speech, non-word symbols, metadata, silences, language characteristics, and acoustic characteristics, the content being attributed to a participant in the interaction. The procedure 500 may further include an operation 508 of populating the form using a machine learning form filling model that draws information from the transcript of the interaction. The machine learning form filling model may be trained using supervised or unsupervised learning.

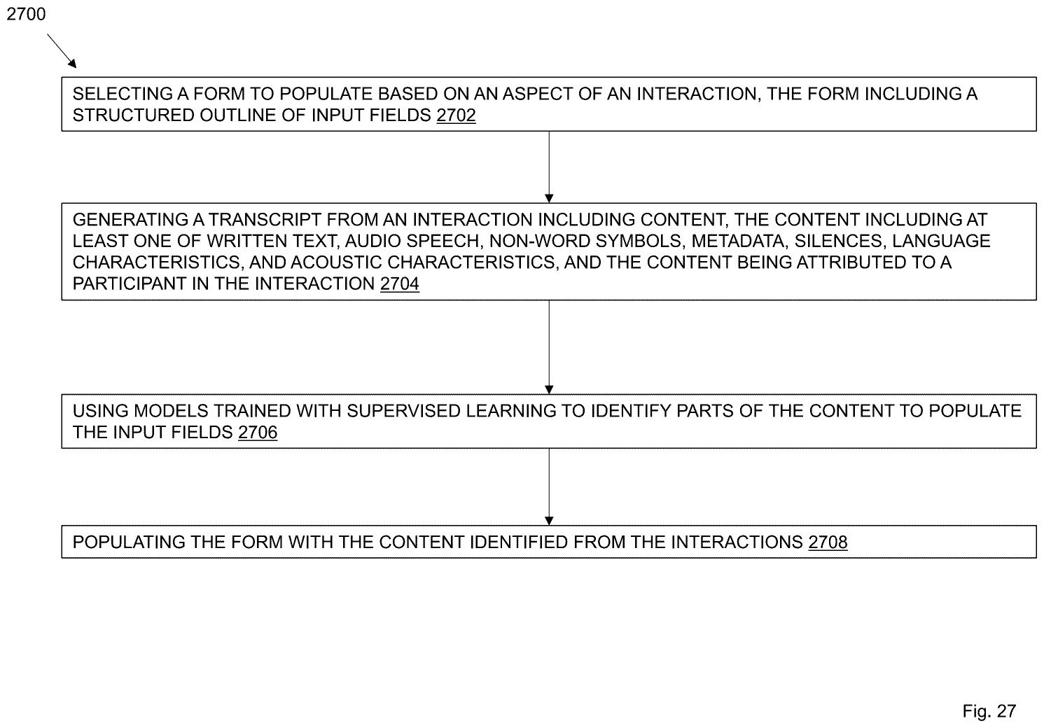

In an embodiment, and referring to FIG. 27, a procedure 2700 for automatically populating a form using supervised machine learning may include an operation 2702 of selecting a form to populate based on an aspect of an interaction, the form including a structured outline of input fields; an operation 2704 of generating a transcript from an interaction including content, the content including at least one of written text, audio speech, non-word symbols, metadata, silences, language characteristics, and acoustic characteristics, and the content is attributed to a participant in the interaction; and an operation 2706 of using models trained using supervised learning to identify parts of the content to populate the input fields. The dataset used in generating the model may include filled out forms having questions and respective populated input fields; each populated input field could be a category or class. Further, the model may be trained to distinguish a possible response for each question in the form. The procedure 2700 may also include an operation 2708 for populating the form with the content identified from the interactions. Supervised machine learning, in some example embodiments, may include one or more neural networks, support vector machines, and the like or a combination of thereof.

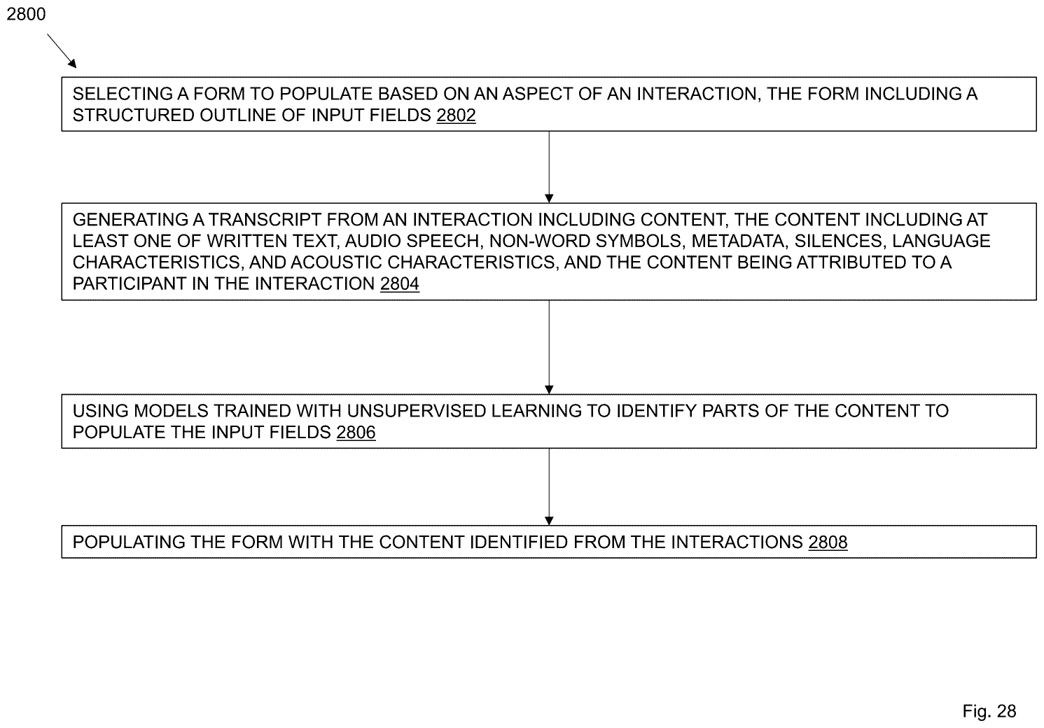

In an embodiment, and referring to FIG. 28, a procedure 2800 for automatically populating a form using unsupervised machine learning may include an operation 2802 of selecting a form to populate based on an aspect of an interaction, the form including a structured outline of input fields; an operation 2804 of generating a transcript from an interaction including content, the content including at least one of written text, audio speech, non-word symbols, metadata, silences, language characteristics, and acoustic characteristics, and the content being attributed to a participant in the interaction; and an operation 2806 of using models trained using unsupervised learning to identify parts of the content to populate the input fields. The dataset used in generating the model may include filled out forms having questions and respective populated input fields. The model may be trained to determine the input field each content part belongs in, if any, based on a similarity measure (e.g. identifying a cluster for the content, where the cluster is for a specific input field). The procedure 2800 may also include an operation for populating the form with the content identified from the interactions 2808. The unsupervised machine learning may include one or more of transformers, networks, clustering, etc., and the like or a combination thereof. In embodiments, as previously described in U.S. Pat. No. 9,413,891, which is incorporated by reference herein, an analysis of all the words contained in a user-defined set of conversations may be performed and commonalities between the interactions identified. The resulting output display of common topics may provide insight into topics or characteristics that are more or less common among the selected set of interactions. The degree of commonality may be expressed as an ordered list, by font size of characteristic, or the like. In embodiments, an output display may be a tree view or as a tag cloud. Both provide a quick visual understanding of what is happening in the communications with no pre-conceived notion (or scripted query) of what to look for. The topic cloud can be alphabetically ordered, sized by frequency, colored by correlative relationship to each other, or the like. While these display options are robust ways to understand the relative frequency of topics relative to each other in a particular group of interactions at a point in time, it may not be useful in understanding the relevance of a topic over time.

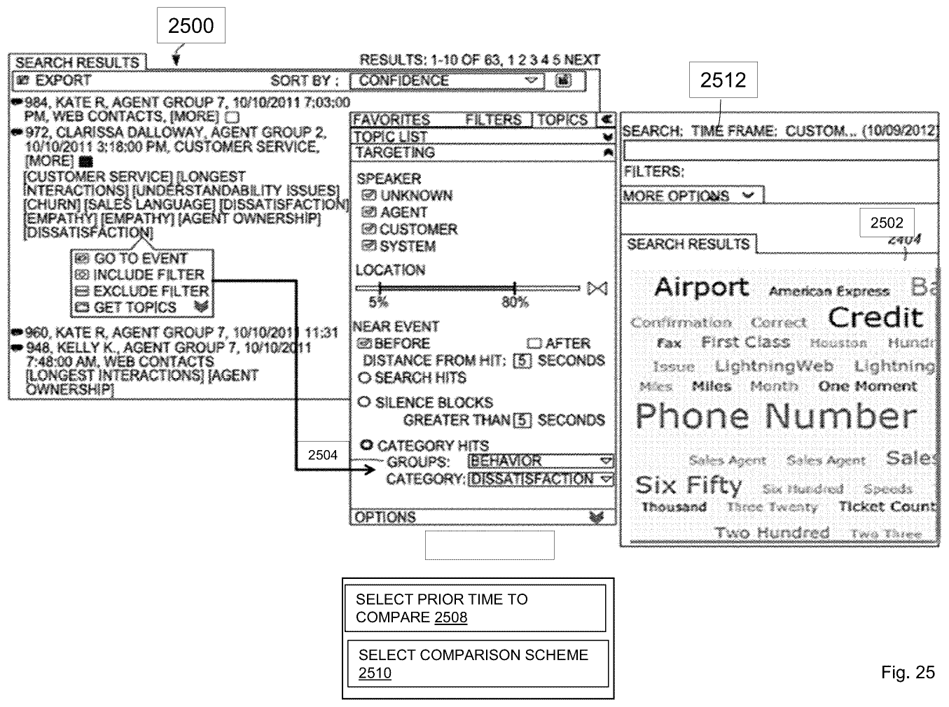

Referring now to FIG. 25, the output display of topics may also have a time domain. In embodiments, the frequency of a topic identified in a set of interactions may be tracked for similar sets of interactions over time. For example, a set of interactions may be defined as all interactions during a night shift in a call center for a company. At the launch of a new product the frequency of a topic related to product availability in the interactions may be high, and over time the frequency of the topic may decrease. In the same example, the frequency of a topic related to a particular defect may be low at product launch but may increase over time. In order to display the change in frequency over time, the topic cloud may add a dimension. For example, a topic cloud for a set of night shift interactions at any one point in time may be made as described previously where the frequency of a topic relative to others is displayed, for example, via a larger font size for the more frequent topic. To visualize the relative increase or decrease in the frequency over time, a heat map may be used where frequency in the time domain is noted with a color spectrum. For example, increased frequency may be displayed using a color (e.g., bright red) while decreasing frequency is displayed using another color on the spectrum (e.g., cool blue). In this way, even if a particular topic is mentioned less frequently relative to other topics in a set of interactions at one point in time and would be displayed with a smaller font in the topic cloud, its increased frequency relative to its frequency in a prior set of interactions can be identified via its color.

Continuing with reference to FIG. 25, a screenshot is shown comprising a user input interface 2500 and an output display of common topics 2502, wherein the user interface enables targeting results by speaker, location, category group 2504, category, timing, silence, and various event attributes. This allows users to get to the facts and contacts that reveal the issues within a conversation set rather than having to sift through each and every contact. In this example, one call is clicked on to ‘Get Topics’ and then a topic cloud is formed. Users may select a current time 2512 to analyze and a prior time 2508 to compare the current frequency of a word against. In addition to using a heat map style coloring indicate frequency, increased hatching or more dense markings may indicate increased frequency. The desired scheme 2510 for indicating frequency may be indicated in the user interface. In this example, the display of topics 2502 shows topics that are more highly frequent in the set, such as ‘Phone Number’ which is displayed in the largest font size, and also shows that the topics ‘Airport’ and ‘Credit’ have increased in frequency relative to a prior time, as they are colored more darkly than other terms, but are still less frequent than ‘Phone Number’ since they are shown in a smaller font size.

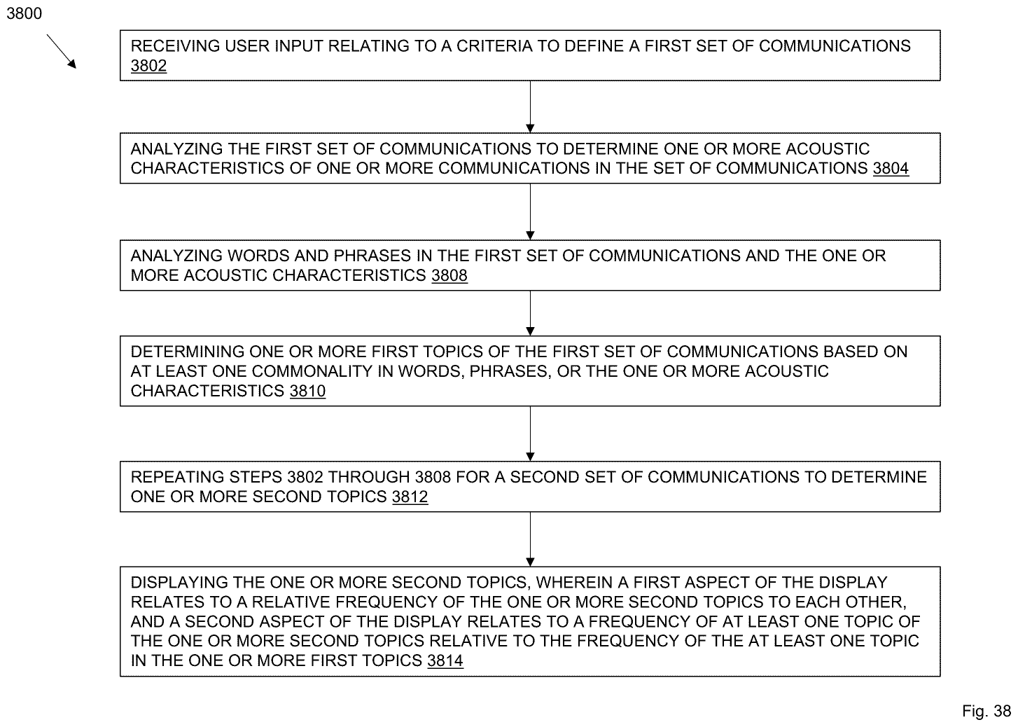

Referring now to FIG. 38, a procedure 3800 for identifying a frequency of a topic over time is depicted. The procedure 3800 may include an operation 3802 of receiving user input relating to a criteria to define a first set of communications. The criteria may be at least one of a category, a score, a sentiment, an agent, an agent grouping, a speaker, a location, an event attribute, a call center, a time of communication, or a date of communication. The procedure 3800 may also include an operation 3804 of analyzing the first set of communications to determine one or more acoustic characteristics of one or more communications in the set of communications. The procedure 3800 may further include an operation 3808 of analyzing words and phrases in the first set of communications and the one or more acoustic characteristics. An operation 3810 may include determining one or more first topics of the first set of communications based on at least one commonality in words, phrases, or the one or more acoustic characteristics. The procedure 3800 may repeat the operations 3802, 3804, and 3808 in operation 3812 for a second set of communications to determine one or more second topics. Operation 3814 of procedure 3800 may involve displaying the one or more second topics, wherein a first aspect of the display relates to a relative frequency of the one or more second topics to each other; and a second aspect of the display relates to a frequency of at least one topic of the one or more second topics relative to the frequency of the at least one topic in the one or more first topics. The first aspect or the second aspect may be is at least one of a size, a color, an opacity, or an order. For example, the first aspect may be a font size and the second aspect may be a color. In some embodiments, the relative frequency of at least one topic of the one or more second topics relative to the frequency of the at least one topic in the one or more first topics may be displayed as an animated change in an aspect, such as an animated change in size, font, color, shape, or the like.

Topic identification is the task when a system is provided with input data, which could be a word or a phrase, a transcribed speech, an emotion, non-word symbols, acoustic features, or any part of a communication; this system can tag and assign a category/topic to the part of the communication. Topic identification has previously involved comparing input data to pre-set lists of topics/categories, and a topic or category is assigned based on a similarity measure. However, communication is dynamic, and having a pre-populated list of language patterns may not be adequate (e.g., not robust). There is a need for topic identification in systems where pre-populated lists are not available, and that may be more robust than pattern recognition.

In embodiments, topic identification may be done using an algorithm, such as Latent Dirichlet allocation (LDA) & Latent Semantic Allocation (LSA) to examine word frequency probability. In embodiments, a population is defined or selected, such as a population of 20 contacts. An unsupervised model is applied to the population to infer the topics of the contacts, resulting in new topics available for future categorization/tagging. In this case, no user has had to go through the contacts to determine, edit, or confirm the topics. When a new contact is made, users may select from the topics identified by the unsupervised model.

FIG. 26 depicts a block diagram of a topic identification system 2600. The topic identification system 2600 may leverage machine learning to learn the relationship between phrases and words in the dataset 2630 in order to generate topics de novo. The topic identification system 2600 may include one or more processors 2610 and one or more computer-readable hardware storage devices, e.g., a memory 2620, having stored computer-executable instructions that are executable by the one or more processors 2610 to cause the topic identification system 2600 to perform operations described herein.

The topic identification system 2600 may train a model for categorizing words or phrases with unsupervised learning. In this example embodiment, the topic identification system 2600 may use clustering 2680, for example, for unsupervised learning. The topic identification system 2600 has a dataset 2630, stored either locally or remotely and accessed from a server or cloud. Further, the dataset 2630 examples may not be labeled. The dataset 2630 consists of words, phrases, non-word symbols, acoustic features or any part of communication. This dataset 2630 may be used by the training module 2640 to generate a model 2660 that could be utilized by the inference-making module 2650 to categorize input data received by the topic identification system 2600, such as during inference-making.

The training module 2640 may use clustering 2680 to cluster words and phrases of the dataset 2630. Each cluster of words and phrases could be a topic/category. Clustering is a machine learning method that detects and identifies patterns in the dataset 2630. The clusters are generated after running the clustering algorithm on the dataset 2630. In an example embodiment, centroid-based clustering may be used. In another embodiment, density-based clustering may be used. In some example embodiments, distribution-based clustering may be used.

In some embodiments, when input data (e.g., words, phrases, and the like from an interaction between two parties, such as a human agent and a human customer) is received by the topic identification system 2600, the inference-making module 2650 uses a model 2660 to determine one or more clusters that the input data belongs in and assigns it a topic accordingly.

In this example embodiment, the training module 2640 may use feature extraction 2670 when creating the model 2660. The feature extraction 2670 may extract features from data (whether input data or dataset 2630), and the clustering 2680 clusters the features.

The features extracted by feature extraction 2670 could be word embeddings, described previously herein. Another advantage of feature extraction 2670 is that feature extraction 2670 represents data in a pre-defined length regardless of the length of the word or the number of words in the phrase.

In the training phase (e.g., model generation stage), the steps include i) generating a model 2660 by the training module 2640 using dataset 2630; ii) extracting features of the examples (data) in the dataset 2630 by the feature extraction 2670; and iii) clustering the extracted features by clustering 2680, which generates the model 2660.

In the inference-making phase, the steps include i) the inference-making module 2650 receiving input data; ii) the feature extraction 2670 extracting features of the input data; and iii) applying the model 2660 to categorize the input data and assign topic(s).

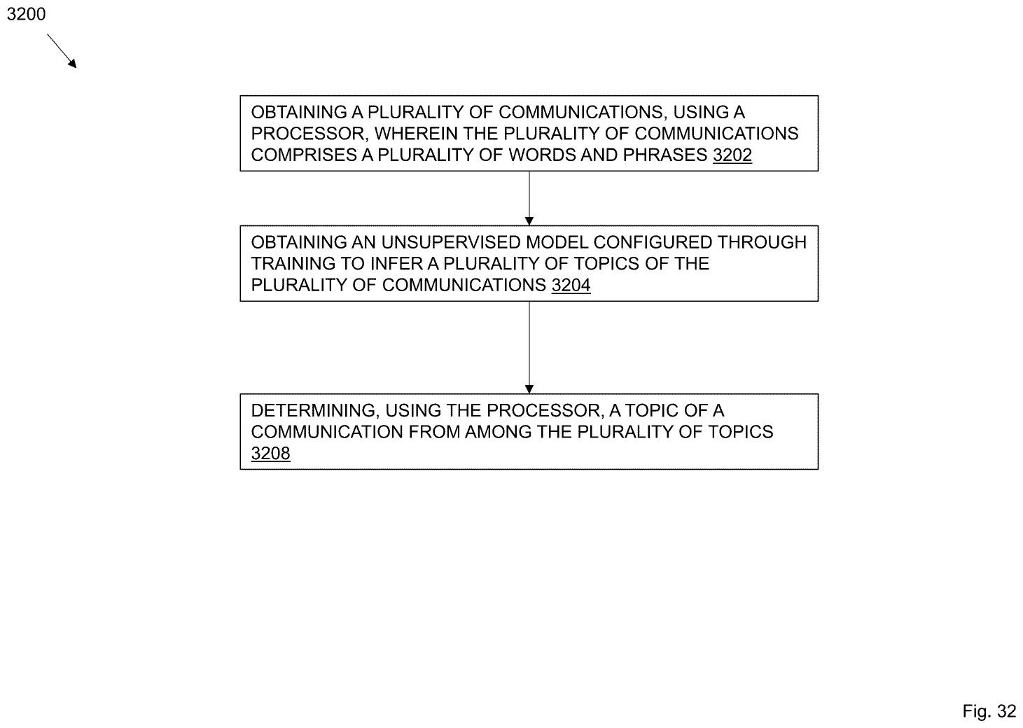

Referring now to FIG. 32, a method 3200 for topic identification may include an operation 3202 of obtaining a plurality of communications, using a processor, wherein the plurality of communications comprises a plurality of words and phrases; an operation 3204 of obtaining an unsupervised model configured through training to infer a plurality of topics of the plurality of communications; and an operation 3208 of determining, using the processor, a topic of a communication from among the plurality of topics.

Machine learning may also be used to provide automated coaching enhancement for customer service agent training via a robot (or “bot”) to customer service agents with automated training and/or coaching based on datasets including training from transcriptions of the customer interactions. Additionally, machine learning may be used to provide real-time analytics of a chat between a human agent and a robot “customer,’ for example, to improve the automated training and provide feedback to the human agent.

Embodiments may include an automated coaching enhancement that uses a robotic coach (“bot”) to practice scenarios for skill improvement evaluation. Based on a conversational artificial intelligence (AI) platform the bot may play the role of the customer to train or practice any scenario that is desired. The bot may leverage traditional AI bot/conversational AI technology including, but not limited to, composer, visual studio, natural language processing (NLP), natural language understanding (NLU), natural language generation (NLG), and intent identification, to interact with human trainees in scenarios in which skill improvement or practice is needed. Training the intent identification could be similar to the aforementioned categorization training. The category, in this example embodiment, could be the intent.

The bot may emulate or simulate a human customer by leveraging transcribed interaction segments from a database system and testing the human agent on areas in which they have been identified to need practice. The designer of the bot may enter into a composer in the bot application, and may introduce the desired scripted interaction segments into the system. For example, a scripted interaction segment may be a customer calling to check on a shipping status, a customer chatting to negotiate a discount, a customer calling for technical support or to set up a repair, or the like. Then, e.g., using NLU/NLG, the bot may be trained on the language in an interaction, such as on datasets from prior actual customer conversations or scripted training interactions, to respond to the human trainees with the next step or conversation point to test and practice the desired scenario.

The bot may generate data on the interaction using an interaction analysis system, and may provide the human trainee with a score of that training session, as well as feedback on ideal path and improvements for optimal outcomes. All of this may be leveraged into a coaching application as a part of a coaching environment, including closed loop functionality (e.g., the ability to automatically share insights and feedback to any and all appropriate or interested entities or segments of an organization in a way that ensures visibility and actionability) as appropriate.

Some applications for the bot, according to certain embodiments, may include: new hire evaluation, language competency evaluation, job fit evaluation, role fit evaluation, skill enhancement, concept mastery, refresher, and/or practice.

Embodiments may interact with the human trainees using one or both of typed (e.g., text) and spoken voice interactions, e.g., via an interactive voice response (IVR) system. IVR is an automated business phone system feature that may interact with a caller, and may gather information by giving the caller choices via a menu. The IVR may then perform actions based on the answers of the caller through the telephone keypad or their voice response. As such, in embodiments, a human agent may talk to a robotic “customer” to be trained, and may receive feedback on interactions in various scenarios with the “customer.” The human agent may be in a training environment with a robot (“bot”) that is trained to provide customer service training, for example, in handling rote tasks or in dealing with difficult or complex situations.

The bot may be developmental. For example, an interaction can be short, and/or interactions can build on each other. One bot may be associated with or triggered by another bot, which may be associated with or triggered by another bot, etc. For example, the interaction introduction may trigger one bot, the reasons for call may trigger a second bot, and knowledge transfer or problem solving may trigger a third bot. The bots may be strung together or may be kept separate to be used for training individually.

In an embodiment, a real-time open voice transcription standard (OVTS) may enable access to streaming audio, e.g., from speech recognition vendors, and may allow for better integrations with conversational intelligence bot providers for interaction with human customers. A human agent may be provided with the bot intelligence and analytics intelligence, e.g., as a “boost” use case.

The data may be provided as a closed loop between a bot conversation and conversations with a human agent that happen afterwards, e.g., phone conversations. Interactions may be two-way, e.g., they may use the phone conversation to further train and/or prepare the bot. For example, the bot may be further trained to act as a robotic “customer” to train or give feedback to a human agent, as described previously.

If a previous interaction records that a human customer left a bot response environment and initiated an interaction with a human customer service agent, the system, such as via the customer service agent model, may analyze the interaction to determine why the human customer left the bot and/or required a human customer service agent (e.g., frustration with speed of interaction, speech not being accurately recognized (e.g., due to a technical defect), the bot may not be able provide a response (e.g. the customer service agent model may not be adequately trained, or is ineffectively trained by all available datasets, or is incapable to provide a response to the human customer's question or the current context, etc.). For example, the human customer may have been interacting with the bot in a first language, then switches to a second language that the bot is not trained in and therefore is incapable of providing a response. In another example, there may be a determination as to why the human customer terminated interaction with the customer service bot, and the system could immediately feed that determination back in the model so that the bot can start to learn how to answer some of those questions or resolve the human customer's issues, even in real time.

It may also be determined that the bot reaches a threshold, or the human customer reaches a threshold, where it is decided that the call needs to be passed off to a human agent. If the trained statements in the bot do not cover the contents of an interaction, or the bot has otherwise reached the extent of its knowledge, the bot may be deemed to have reached a threshold. For example, acoustic features may be monitored, and a threshold may be set for a particular volume of the customer's voice, utterance of profanities, or the like. Even when the human agent is involved, the bot may stay on the call, and may provide support to the agent, e.g., the bot may become a third participant in the conversation. In embodiments, the bot may be able to communicate directly with only the human agent or with both the human agent and the customer.

In embodiments, the effectiveness of the training bot may be determined using tools to determine a current behavior and/or performance of the agent as compared to a past behavior and/or performance.

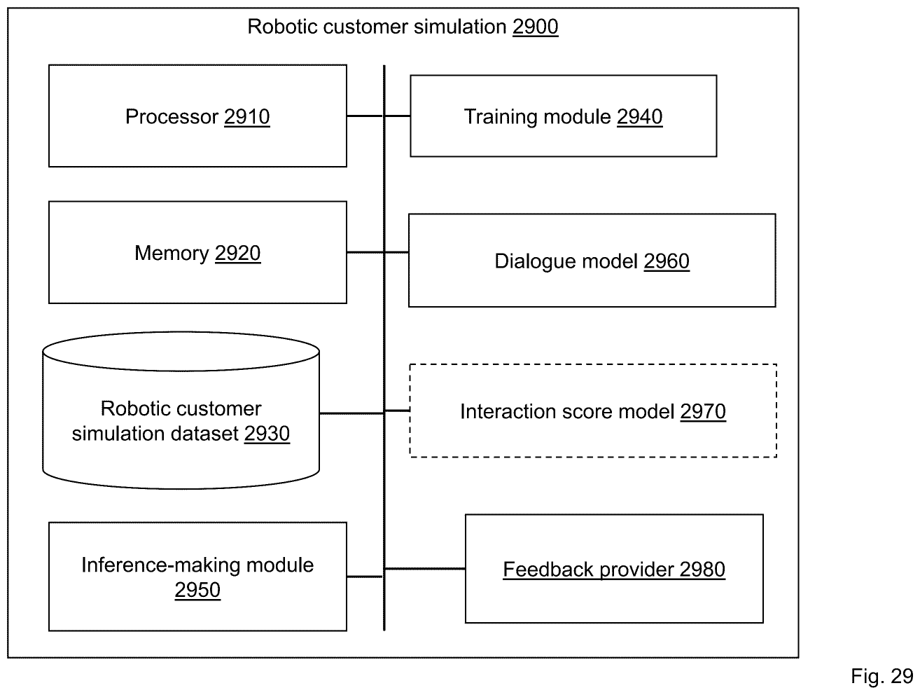

FIG. 29 illustrates a diagram of a robotic customer simulation 2900, which is a system. The robotic customer simulation 2900 may include one or more processors 2910 and one or more computer-readable hardware storage devices, e.g., a memory 2920, having stored computer-executable instructions that are executable by the one or more processors 2910 to cause the robotic customer simulation 2900 to perform operations described herein. The robotic customer simulation 2900 has a training module 2940 to generate a dialogue model 2960 and an optional interaction score model 2970. Dashed lines indicate an optional component. The robotic customer simulation 2900 has a robotic customer simulation dataset 2930 comprising interactions between human agents and human customers. NLP techniques may be used by the training module 2940 to analyze the underlying interactions, which may include the use of one or more of GPT-3 (Brown, Tom, et al. “Language models are few-shot learners.” Advances in neural information processing systems 33 (2020): 1877-1901), included herein by reference, GPT-4 (OpenAI. “GPT-4 Technical Report.” arXiv:2303.08774 (2023), incorporated herein by reference, BERT (Devlin, Jacob, et al. “Bert: Pre-training of deep bidirectional transformers for language understanding.” arXiv preprint arXiv:1810.04805 (2018)), incorporated herein by reference, RoBERTa (Liu, Yinhanr et al. “Roberta: A robustly optimized BERT pretraining approach.” arXiv preprint arXiv:1907.11692 (2019)), incorporated herein by reference, or the like of other models and machine learning algorithms. The aforementioned models could be used by the training module 2940 and be fine-tuned for mapping human customer questions to human agent responses.

The robotic customer simulation dataset 2930 may also include information on whether each interaction between the human agent and the human customer was productive or not (e.g., did it resolve the issue, was the human customer happy, etc.). This entry could be in the form of a score or category. This interaction score could be either annotated by a human when compiling the robotic customer simulation dataset 2930, a survey filled out by the human customer, or automatically annotated by an interaction score model 2970 (e.g., using machine learning). The interaction score model 2970 could detect emotions, whether acoustic or linguistic, and determine whether the human customer was happy, angry, frustrated, etc., and score the response accordingly.

During inference making, by the inference making module 2950, the robotic customer simulation 2900 may provide the human agent with a question, and expect a response. Based on the response, the robotic customer simulation 2900, via applying the dialogue model 2960, may determine another response, and so on. Therefore, the robotic customer simulation 2900 carries out a conversation, whether by voice or text, and acts as a coach for the human agent. Based on the human agent's response, the dialogue model 2960 may also score the agent's response. The scoring could be by identifying the interaction score of the closest response in the robotic customer simulation dataset 2930 or by predicting the interaction score through the interaction score model 2970. The interaction score model 2970 could be a model trained on predicting the interaction score of the robotic customer simulation dataset 2930. In example embodiments, the interaction score model 2970 may be trained based on the question-response pairs in the robotic customer simulation dataset 2930.

The feedback provider 2980 provides feedback to a human agent on the trained session performed. In example embodiments, the feedback could be based on the interaction score of each portion of interaction (e.g., every question asked by the robotic customer simulation 2900 and response provided by the human agent). Hence, a detailed report may be provided for strengths and weaknesses of the human agent and suggestions for areas for improvement. In other example embodiments, a single score may be provided for the training session, such as a training session score. This single score is a function of the interaction scores for every question and response. The function could be a weighted average, median, maximum, or other mathematical function. This type of score gives a high-level performance measure of the training session. In example embodiments, both scores may be provided, interaction scores and training session scores.

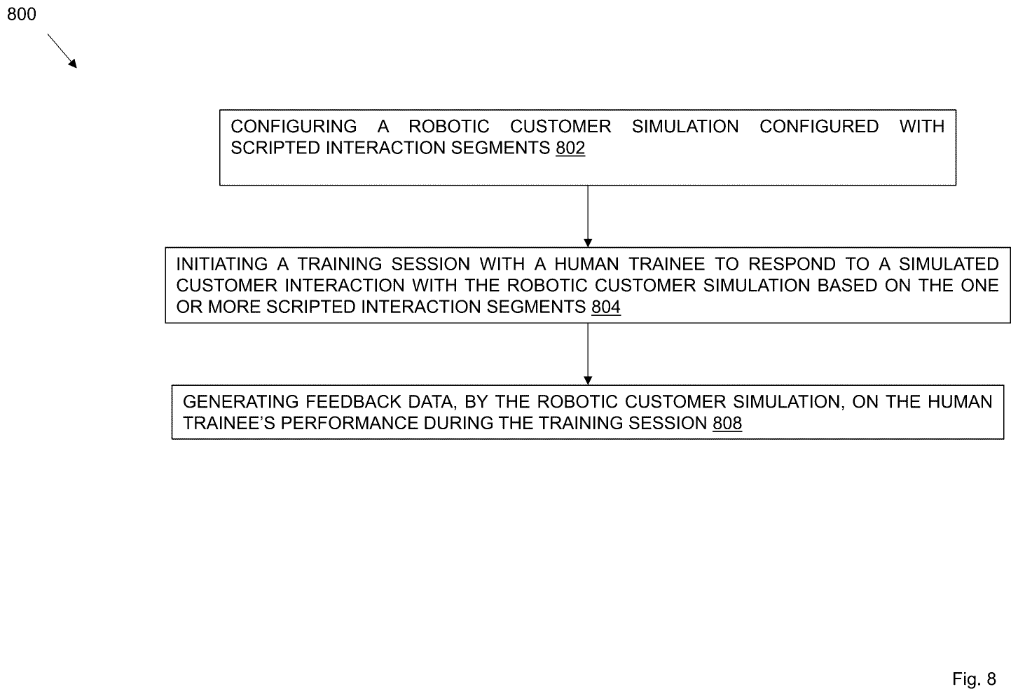

In an embodiment, and referring to FIG. 8, a method 800 may include configuring a robotic customer simulation with one or more scripted interaction segments, the robotic customer simulation executing a machine learning dialogue model (802), initiating a training session with a human trainee to respond to a simulated customer interaction with the robotic customer simulation based on the one or more scripted interaction segments (804), and generating feedback data, by the robotic customer simulation, on the human trainee's performance during the training session (808). The robotic customer simulation may be trained to provide a next step in the scripted interaction segment or a conversation point. Generating feedback data may include analyzing acoustic and language characteristics of the training session; and determining at least one of a category label or an agent quality score to associate with the training session.

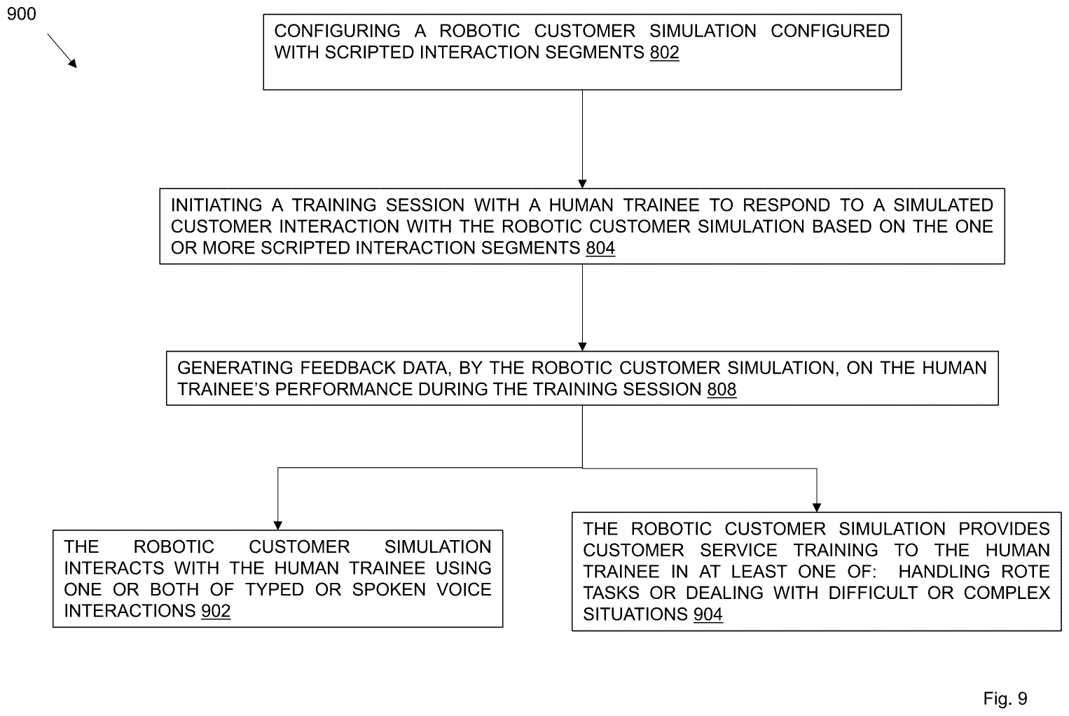

Referring to FIG. 9, in the method 900, the robotic customer simulation may interact with the human trainee using one or both of typed or spoken voice interactions (902). In the method, the spoken voice interactions may be provided via an interactive voice response (IVR) system. In the method, the feedback may include a score of the training session (e.g., training session score, or in other example embodiments, the score may be a vector of interaction scores). In the method 800, the feedback may include suggestions for improvements for optimal outcomes with human customers. In the method 900, the training session may include at least one of: a new hire evaluation, language competency evaluation, job fit evaluation, role fit evaluation, skill enhancement, concept mastery evaluation, refresher, and/or practice. In the method 900, the robotic customer simulation may provide customer service training to the human trainee in at least one of: handling rote tasks or dealing with difficult or complex situations (904). In the method, the robotic customer may be associated with another robotic customer simulation, and each of the robotic customer simulation and the other robotic customer simulation may be trained to handle a respective customer service situation. The dialogue model may be trained on a dataset having questions and responses between human agents and human customers. Generating feedback data may include analyzing acoustic and language characteristics of the training session, and determining at least one of a category or an agent quality score to associate with the training session. The feedback data may include a training session score for the training session, the training session score being a function of scores for responses provided to the robotic customer simulation. The feedback data may include an interaction score as a vector of scores, wherein each score is for a trainee response to the robotic customer simulation. The robotic customer simulation may further include executing an interaction score model, wherein the interaction score model is configured through training to provide an interaction score. In embodiments, the robotic customer simulation is associated with a second robotic customer simulation, and the second robotic customer simulation may have a second dialogue model trained to handle a respective customer service situation.

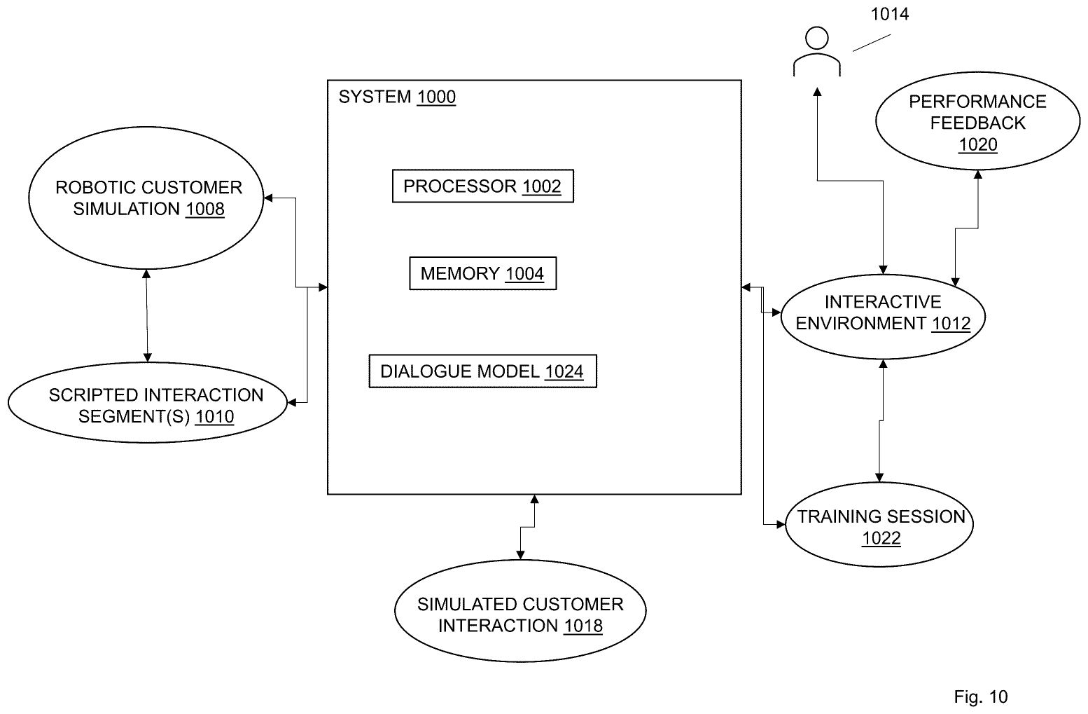

In an embodiment, and referring to FIG. 10, a system 1000 may include one or more processors 1002 and one or more computer-readable hardware storage devices, e.g., a memory 1004, having stored computer-executable instructions that are executable by the one or more processors 1002 to cause the system 1000 to at least: provide a robotic customer simulation 1008 configured with one or more scripted interaction segments 1010, based on an artificial intelligence (AI) system. The robotic customer simulation 1008 may be configured with one or more scripted interaction segments 1010, the robotic customer simulation 1008 executing a dialogue model 1024, wherein the dialogue model 1024 is configured through training to provide a next step in a scripted interaction segment 1010 or a conversation point. The system 1000 may also provide an interactive environment 1012 for a training session 1022 with a human trainee 1014 to respond to a simulated customer interaction 1018 with the robotic customer simulation 1008 based on the one or more scripted interaction segments 1010. The system 1000 may also generate feedback data to provide the human trainee 1014 with feedback on performance 1020 by the human trainee 1014 during the training session 1022. Generating feedback data may include analyzing acoustic and language characteristics of the training session, and determining at least one of a category or an agent quality score to associate with the training session. The feedback data may include a training session score for the training session, the training session score being a function of scores for responses provided to the robotic customer simulation. The feedback data may include an interaction score, which is a vector of scores, wherein each score is for a trainee response to the robotic customer simulation. The robotic customer simulation may further execute an interaction score model, wherein the interaction score model is configured through training to provide an interaction score.

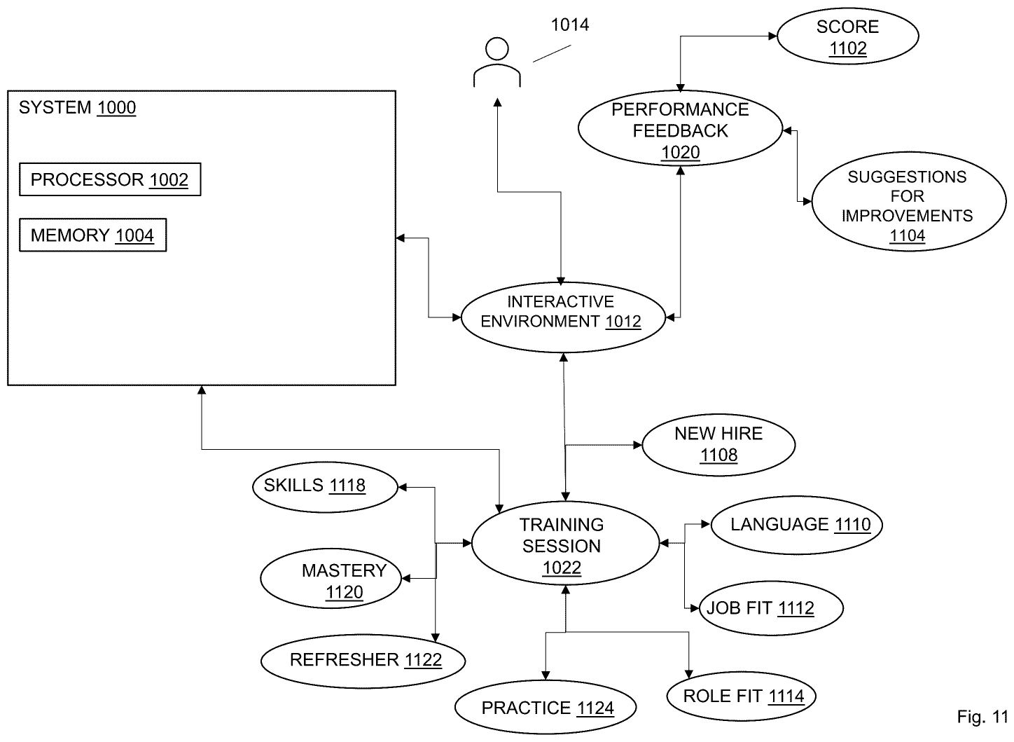

Referring to FIG. 11, in the system 1000, the performance feedback 1020 may include a score 1102 (e.g., training session score) of the training session 1022. In some other example embodiments, the score may be a vector comprising interaction scores. In the system 1000, the feedback on performance 1020 may include suggestions for improvements 1104 for optimal outcomes with human customers. In the system 1000, the training session may include at least one of the following: a new hire evaluation 1108, language competency evaluation 1110, job fit evaluation 1112, role fit evaluation 1114, skill enhancement 1118, concept mastery evaluation 1120, refresher 1122, and/or practice 1124.

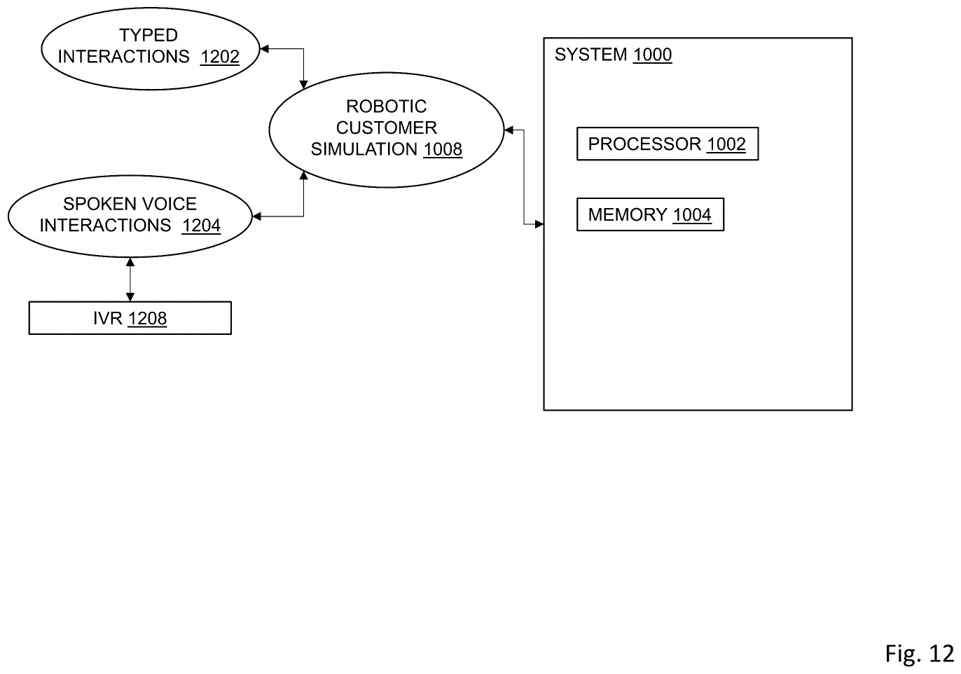

Referring to FIG. 12, in the system 1000, the robotic customer simulation 1008 may interact with the human trainee 1014 using one or both of typed interactions 1202 or spoken voice interactions 1204. In the system 1000, the spoken voice interactions 1204 may be provided via an interactive voice response (IVR) system 1208. In the system 1000, the robotic customer simulation 1008 may provide customer service training to the human trainee in at least one of: handling rote tasks or dealing with difficult or complex situations.

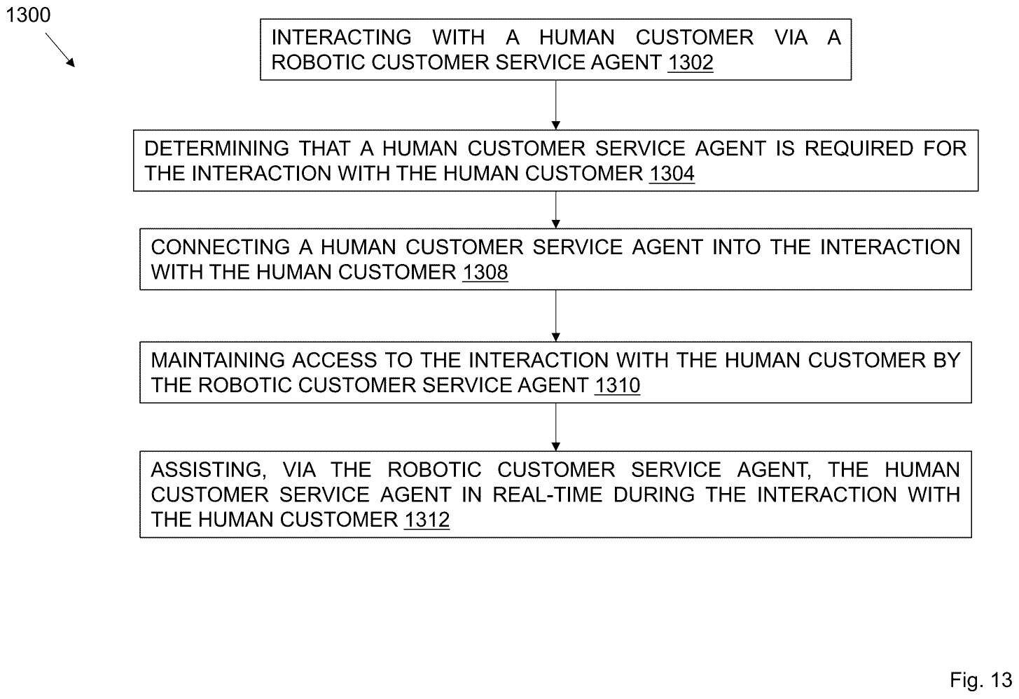

In an embodiment, and referring to FIG. 13, a method 1300 may include interacting with a human customer via a robotic customer service agent (1302), determining that a human customer service agent is required for the interaction with the human customer (1304), connecting a human customer service agent into the interaction with the human customer (1308), maintaining access to the interaction with the human customer by the robotic customer service agent (1310), and assisting, via the robotic customer service agent, the human customer service agent in real-time during the interaction with the human customer (1312). The robotic customer service agent may have a customer service agent model configured through training to respond to questions. The at least one response from the customer service agent model may be based on at least one previous interaction with an optimal outcome.

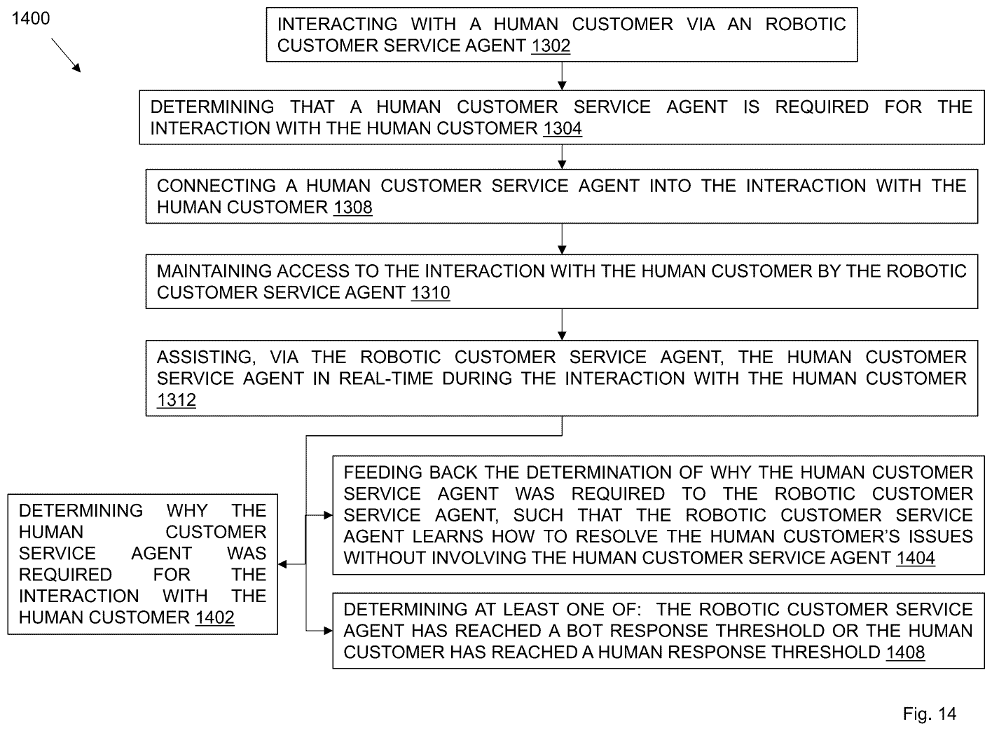

Referring to FIG. 14, the process 1400 may further include a process 1400 for determining why the human customer service agent was required for the interaction with the human customer (1402). The method 1300 may further include feeding back the determination of why the human customer service agent was required to the robotic customer service agent, such that the robotic customer service agent learns how to resolve the human customer's issues without involving the human customer service agent (1404). The process 1300, 1400 may further include feeding back the determination of why the human customer service agent was required to the robotic customer service agent. This feedback could be in the form of training data for the robotic customer service agent. In particular, training, fine-tuning, or further training the customer service agent model. In the method 1300, the determining that a human customer service agent is required may include determining at least one of: the robotic customer service agent has reached a bot response threshold or the human customer has reached a human response threshold (1408).

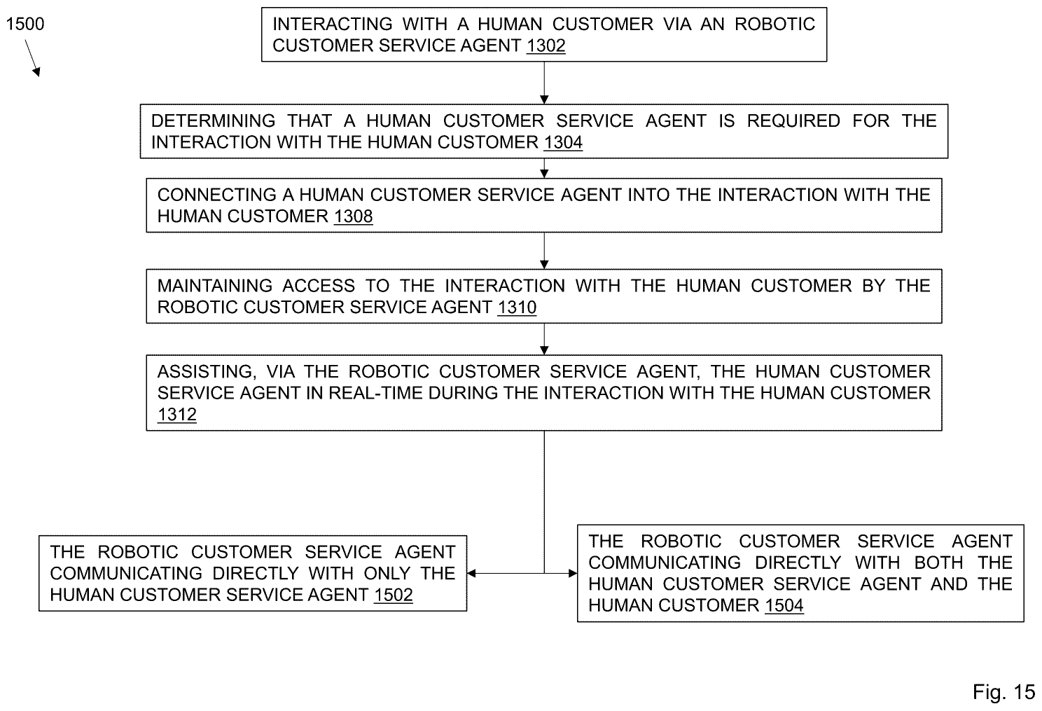

Referring to FIG. 15, in the method 1500, the robotic customer service agent assisting the human customer service agent in real-time during the interaction with the human customer may include the automated robotic customer service agent communicating directly with only the human customer service agent (1502). In the method 1500, the automated robotic customer service agent assisting the human customer service agent in real-time during the interaction with the human customer may include the automated robotic customer service agent communicating directly with both the human customer service agent and the human customer (1504).

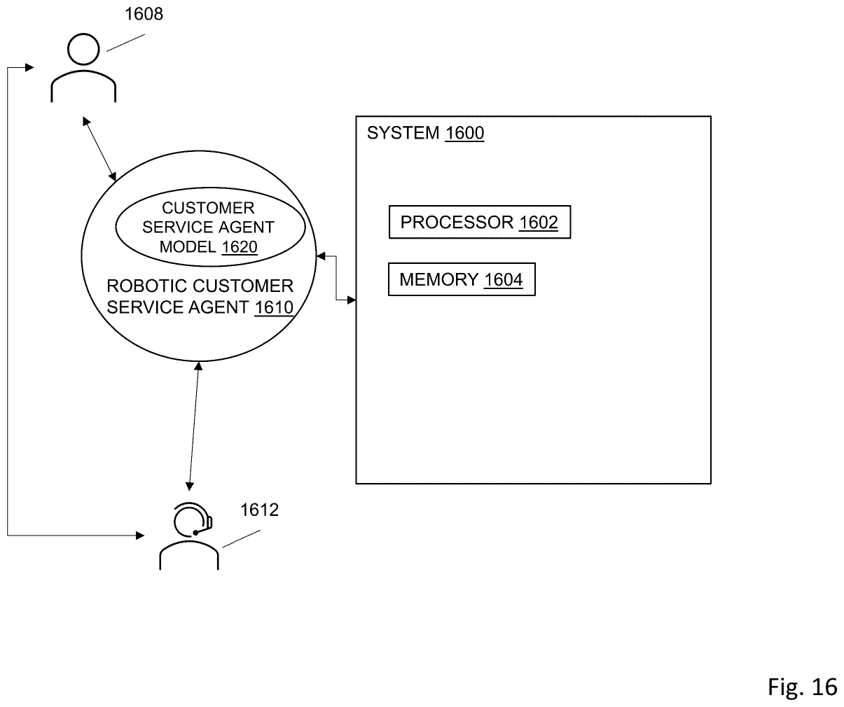

In an embodiment, and referring to FIG. 16, a system 1600 may include one or more processors 1602 and one or more computer-readable hardware storage devices, e.g., a memory 1604, having stored computer-executable instructions that are executable by the one or more processors 1602 to cause the system 1600 to at least: interact with a human customer 1608 via an robotic customer service agent 1610, which comprises a customer service agent model 1620, determine that a human customer service agent 1612 is required for the interaction with the human customer 1608, connect the human customer service agent 1612 into the interaction with the human customer 1608, maintain access to the interaction with the human customer 1608 by the robotic customer service agent 1610, and assist, via the robotic customer service agent 1610, the human customer service agent 1612 in real-time during the interaction with the human customer 1608.

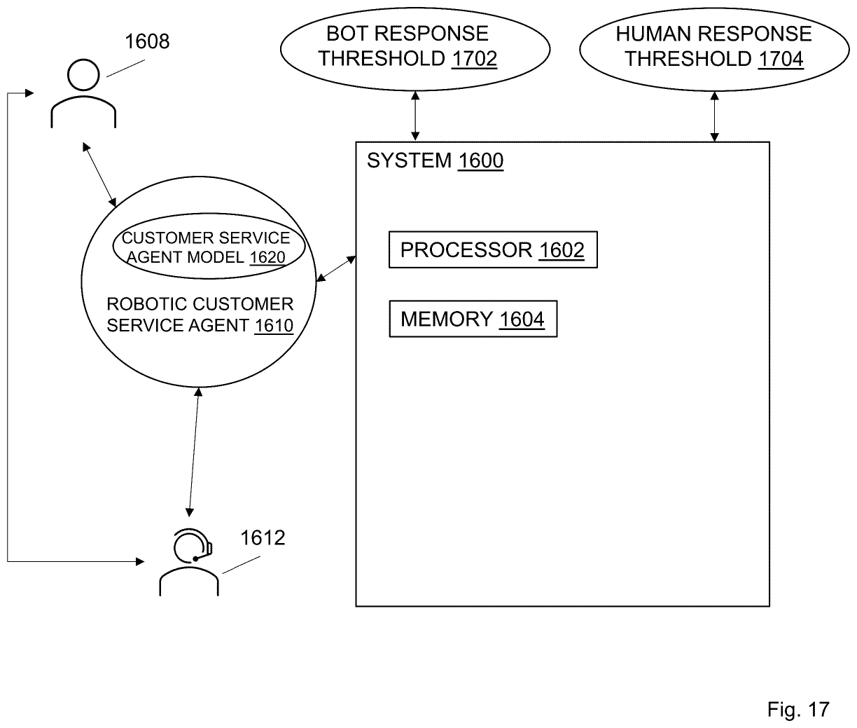

Referring to FIG. 17, in the system 1600, the determining that a human customer service agent is required may include determining at least one of: the robotic customer service agent has reached a bot response threshold 1702 or the human customer has reached a human response threshold 1704. The system 1600 may further include instructions to cause the system to determine why the human customer service agent was required for the interaction with the human customer. The system 1600 may further include instructions to cause the system to feed back the determination of why the human customer service agent was required to the robotic customer service agent as training data, such that the robotic customer service agent learns how to resolve the human customer's issues without involving the human customer service agent. In the system, the robotic customer service agent assisting the human customer service agent in real-time during the interaction with the human customer may include the robotic customer service agent communicating directly with only the human customer service agent. In the system, the robotic customer service agent assisting the human customer service agent in real-time during the interaction with the human customer may include the robotic customer service agent communicating directly with both the human customer service agent and the human customer. In aspects of the system, the at least one response from the customer service agent model 1620 may be based on at least one previous interaction with an optimal outcome.

As disclosed herein, the coaching system, which may be embodied as or also known as the robotic customer service agent, could be a third party in the interaction, whether silent or not, that evaluates interactions between a human agent and a human customer. The coaching system could also provide the human agent with real-time input helping the human agent with how to respond to the human customer.

In example embodiments, a robotic customer service agent having a robotic customer service agent model 1620 is disclosed. The robotic customer service agent model 1620 may be a model trained based on datasets of questions and responses and may be capable of providing a response to the human customer to facilitate the conversation. The robotic customer service agent model 1620 can be based on a fine-tuned NLP model, which may include the use of one or more of GPT-3 (Brown, Tom, et al. “Language models are few-shot learners.” Advances in neural information processing systems 33 (2020): 1877-1901), included herein by reference, GPT-4 (OpenAI. “GPT-4 Technical Report.” arXiv:2303.08774 (2023), incorporated herein by reference, or BERT (Devlin, Jacob, et al. “Bert: Pre-training of deep bidirectional transforrners for language understanding.” arXiv preprint arXiv:1810.04805 (2018)), incorporated herein by reference, RoBERTa (Liu, Yinhan, et al. “Roberta: A robustly optimized BERT pretraining approach.” arXiv preprint arXiv:1907.11692 (2019)), incorporated herein by reference, or the like of other models and machine learning algorithms. The robotic customer service agent model 1620 may also be generated by supervised machine learning methods that allow for mapping questions to responses, or unsupervised machine learning methods, such as clustering, that allow providing responses based on unlabeled data. The robotic customer agent model, may also be trained to identify emotion from the human customer (e.g., acoustics).

In example embodiments, the robotic customer service agent may determine that it could not provide a response; the customer agent is unhappy, frustrated, or angry; or the human customer requests to speak to a human agent, and other scenarios. In these situations, the robotic customer agent may request a human agent to take over the conversation. The robotic customer agent may also stay online, and in some embodiments, in the background, assist the human agent with responses to the human customer. These responses fed to the agent may be generated by the robotic customer service agent model 1620 based on previous interactions having positive outcomes (e.g., made the human customer happy, resolved the issue, encouraged them to purchase product, etc.).

Machine learning may also be used to determine the quality and usefulness of human-to-human coaching and human-to-human meeting interactions, eliminating the need for human interpretation to decide how well the coaching was performed or how successful a meeting was.

Embodiments may include methods and systems for providing automated coaching analytics and meeting analytics via the coaching system. Embodiments may provide a layer of analytics on coaching interactions. For example, these may be coaching sessions that occur between human supervisors and human agents.

In certain embodiments, a coaching environment, e.g., a “Coach” product or platform, may include an “insights” function. The “insights” function may analyze a text-based discussion, e.g., including back-and-forth or two-way communication, between a human agent and a human supervisor, or between a coaching/training bot and a human, which may be sourced, for example, from a text chat and/or a transcript of a spoken voice interaction. Mining in the coaching environment may be similar to mining a contact interaction. Embodiments will be able to mine the dialog for insights and behavioral patterns that will lead to more effective coaching, performance improvement, and agent/employee satisfaction. In certain embodiments, a coaching session score may be automatically generated based on the analytics. In certain embodiments, the analytics may be generated after the meeting, concurrently during the meeting, or in real-time. A coaching session score can contain any number of indicators. In some embodiments, users of the system can customize what the score contains and which indicators (categories, filters, etc.) to use.

Meetings between supervisors and agents were historically in-person, for example, on the floor of a call center or a meeting room. A great many call centers have moved to a work-from-home (WFH) model. Many meetings between supervisors and agents are now conducted online, e.g., via online meetings in ZOOM™, GOOGLE MEET®, and MS TEAMS®. (All trademarks are the property of their respective owners.) These meetings, either in-progress or post-meeting, can be mined for elements of the interaction using machine-learning to look for important features of the conversation, such as by using an integrated API. Available data from the meeting/interaction may include the actual transcript of the conversation itself, combined with additional data or metadata ingested for correlation purposes.

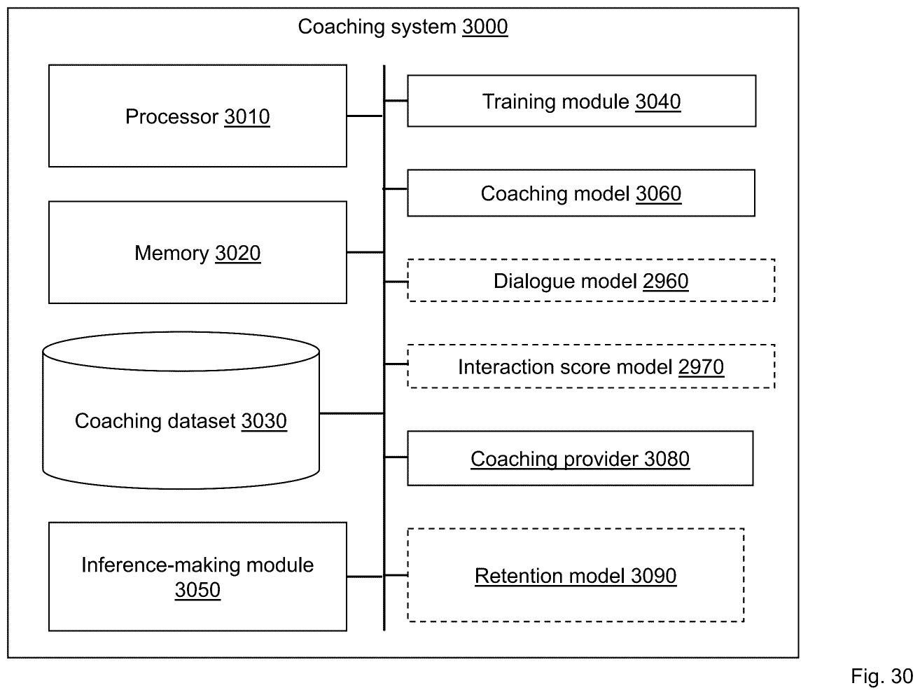

FIG. 30 shows a coaching system that evaluates an interaction and could also feed human agents with responses that historically resulted in a positive or optimal outcome. The coaching system 30 may include one or more processors 3010 and one or more computer-readable hardware storage devices, e.g., a memory 3020, having stored computer-executable instructions that are executable by the one or more processors 3010 to cause the coaching system 3000 to perform certain operations described herein. The coaching system 3000 has a training module 3040 to generate the coaching model 3060. The coaching system 3000 may have a coaching dataset 3030 comprising interactions between human agents and human supervisors. The coaching dataset 3030 may also include data related to coaching effectiveness behaviors, coaching experiences (which may be derived from employee satisfaction data), employee engagement, customer satisfaction or success (including customer interview responses), product mentions, sentiments, process questions, competitive insights, product level insights, win-loss analysis (which may be derived from survey data), sales data, and employee wellbeing may be considered important features to include in the analytics. As an example, keywords, pauses between words or sentences, repetitions of words or phrases, and other aspects of the conversation, including acoustic features, non-word symbols, and the like, can be mined to generate the dataset.

The coaching system 3000 may optionally also include a dialogue model 2960 and interaction score model 2970, similar to those described in FIG. 29. The dialogue model 2960 and interaction score model 2970 may be trained based on interactions between human agents and human customers and capable of determining responses to questions. Therefore, the coaching system could provide the agent with responses. Based on the human agent's response, the dialogue model 2960 may also score the agent's response. The scoring could be by identifying an interaction score as explained above for robotic customer simulation in FIG. 29. The coaching system 3000 may also determine an employee quality score, which may be a function of the interaction scores of the agent (or employee). The employee quality score could be a weighted average, maximum, minimum, or any mathematical function of the interaction scores and may be a measure of historical interaction scoring between the employee and human customers. The dialogue model 2960 in the coaching system 3000 may help the agent to respond to the human customer. The output to the agent may be provided by the inference-making module 3050 for agent use. Also, for each employee, the coaching system 3000 could determine and store an employee specific dataset having the interaction scores of each agent (employee). Hence, the interaction score is associated with the interaction between the human agent and the human customer.

When generating the coaching model 3060 by the training module 3040, NLP techniques may be used to analyze the underlying interaction using NLP models that could be fine-tuned, through training on the coaching dataset 3030, to generate the coaching model 3060 capable of at least one or more of i) generating plausible responses and ii) evaluating the quality of agent-supervisor response. The inference-making module 3050, through the coaching provider 3080 provides an analysis to improve coaching with the agent. This analysis could include a coaching session score. Analytics may be presented in a separate application, in the online meeting application, transmitted through email or chat, or the like. The coaching provider 3080 may be further programmed to provide feedback to the agent. and the coaching system 3000 may further include a retention model 3090, which may be a model configured to determine the likelihood of retaining an employee or an agent.

In an embodiment, the output of a coaching session or a meeting may be a transcript or recording of the session or meeting along with the analytics for that session or meeting. The package may shared, presented, transmitted, or otherwise accessible to any relevant team members.

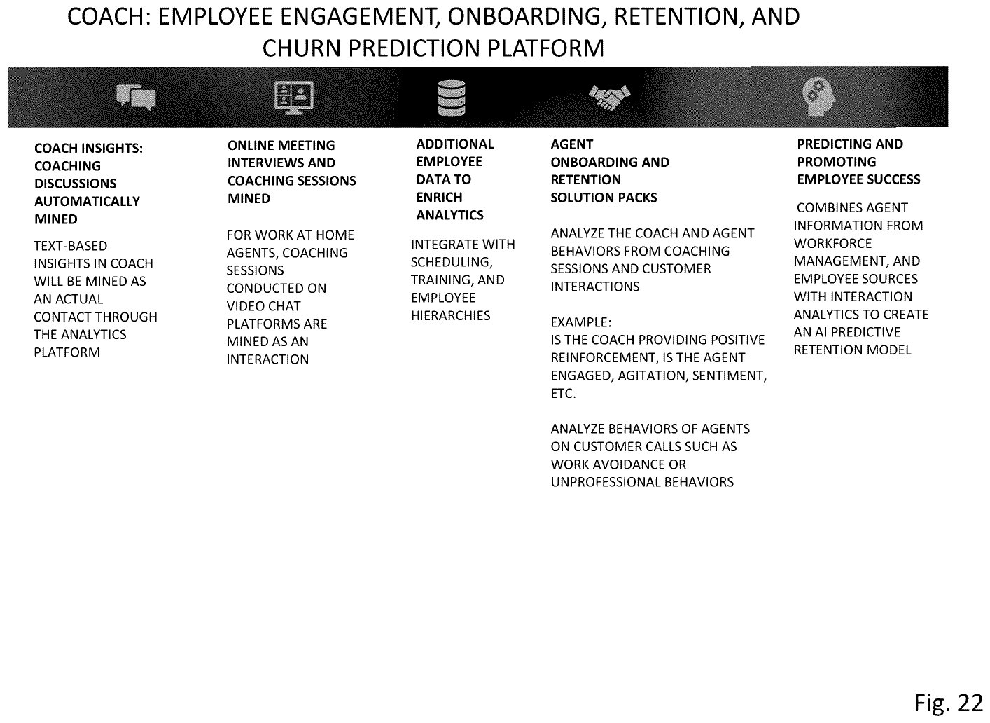

Referring to FIG. 22, additional employee data may be leveraged to enrich analytics, such as by integrating with scheduling, training, and employee hierarchies. The coaching environment may be leveraged for agent onboarding and retention. For example, coach and agent behaviors from coaching sessions and customer interactions may be analyzed to provide insights such as, “Is the coach providing reinforcement?”, “Is the agent engaged?”, “Is the agent demonstrating agitation, sentiment, etc.?”, or “Is the agent demonstrating work avoidance or unprofessional behaviors?”.

In embodiments, the coaching system 3000 may function as an employee engagement, retention, churn, and prediction platform. The coaching system 3000 may be used to predict and promote employee success. This is performed by including in the coaching dataset 3030 agent information from workforce management and employee sources, such as at least one of employee scheduling, employee training, employee hierarchies, or workforce management, including information about employee retention (“workforce data”), and at least one of a category label, an employee quality score, or an interaction score of one or more of a plurality of communications.

The training module 3040 may generate a retention model 3090, which is a machine learning model trained on the coaching dataset 3030 along with agent (or employee) information, employee sources, and the interaction analytics provided by the coaching model 3060. The coaching system 3000 may also provide through the coaching provider 3080 at least one positive reinforcement to the agent.

In embodiments a system for predicting employee retention may include one or more processors, and one or more computer-readable hardware storage devices having stored computer-executable instructions that are executable by the one or more processors to cause the system to at least obtain a training dataset including information about a plurality of employees, wherein the information includes at least one of employee scheduling, employee training, employee hierarchies, or workforce management, including information about employee retention (“workforce data”), and at least one of a category, an employee quality score, or an interaction score of one or more of the plurality of communications, and generate a retention model based on the training dataset, the retention model being able to determine a likelihood of a retention of the employee. The category may be determined by analyzing acoustic and language characteristics of the plurality of communications, wherein the interaction score is based on at least one acoustic, prosodic, syntactic, or visual feature of an interaction of the plurality of communications, and wherein the employee quality score is based on at least one of a nature of customer interactions, an employee work hours and schedule, a training provided, a coaching feedback provided, an interaction quality, or frequency with supervisors. The employee quality score may be a measure of historical interaction scoring between an employee and one or more human customers. The retention model may be configured to generate the likelihood of the employee's retention based on receiving at least one of a category, an employee quality score, or a workforce data, and predict, via the trained model, the likelihood of the employee's retention. Based on the likelihood of the employee's retention, the processor may be further programmed to deliver at least one positive reinforcement. The processor may be further programmed to trigger an alert based on the likelihood.

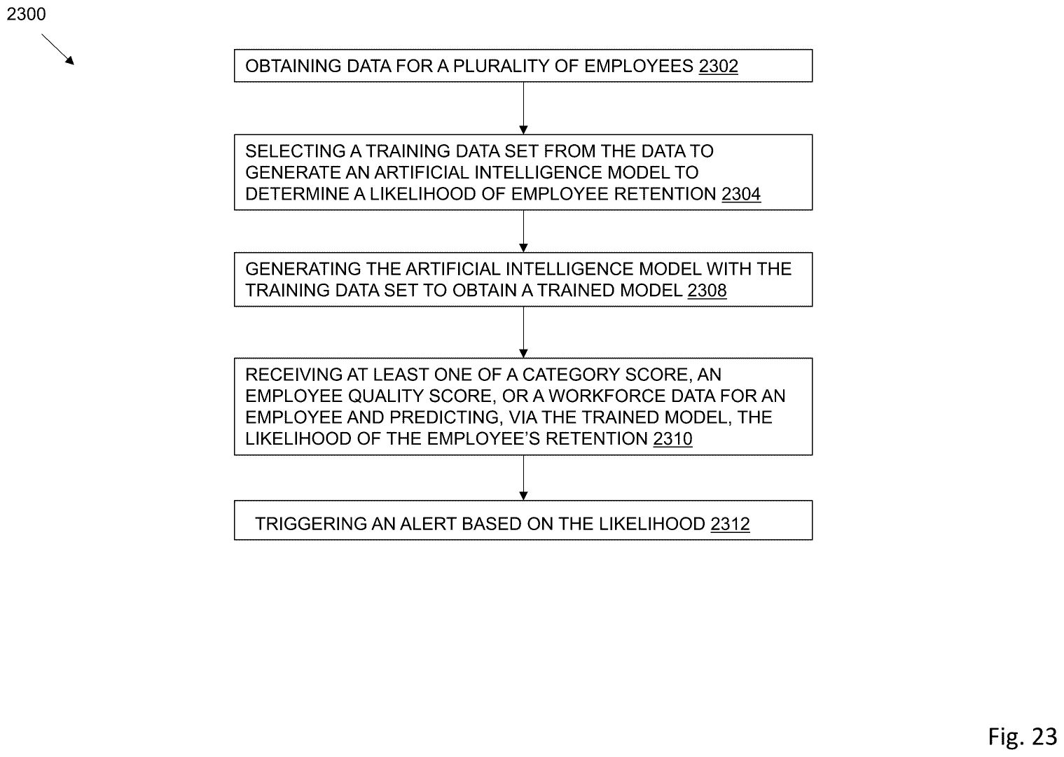

In an embodiment, and referring to FIG. 23, a method 2300 of a retention model may include obtaining data for a plurality of employees 2302. The data may be derived from at least one of employee scheduling, employee training, employee hierarchies, or workforce management, including information about employee retention (“workforce data”), and analyzing acoustic and language characteristics of a plurality of communications between customers and the plurality of employees, and determining at least one of a category label or an employee quality score to associate with one or more of the plurality of communications. The data may be in key-value pairs as metadata. The data may be made feature ready, and in some embodiments, may be converted or normalized for processing by the predictive retention model. In some embodiments, the category labels may be as described, including the process for determining the category label, in U.S. Pat. No. 9,413,891, which is incorporated by reference herein. In some embodiments, the category label may be a basic identifier associated with the prediction. Labels could be a wide variety such as “at risk”, or labels associated with suggestions of training required. In some embodiments, the process for category labelling may be user-defined, or based on known logical groups determined by analysis of user datasets. In some embodiments, some variables that may be included in an employee quality score include: nature of customer interactions, employee work hours and schedule, training provided, coaching feedback provided, interaction quality and frequency with supervisors, and the like.

The method 2300 may further include selecting a training dataset (e.g., coaching dataset 3030 in FIG. 30) from provided data to generate an artificial intelligence model (e.g., retention model 3090 in FIG. 30) to determine the likelihood of employee retention 2304, then generate the artificial intelligence model with the training data set to obtain a trained model 2308 (e.g., retention model 3090 in FIG. 30). The method 2300 may further include receiving at least one of a category score, an employee quality score, or a workforce data for an employee and predicting, via the trained model (e.g., retention model 3090), the likelihood of the employee's retention 2310. The likelihood could take multiple forms, including a score, which may include weighted variables, or a simply binary output.

Based on the likelihood of the employee's retention, the method 2300 may further include delivering at least one positive reinforcement (e.g., such as via coaching provider 3080 in FIG. 30). The method 2300 may further include triggering an alert, action, or review based on the likelihood 2312. Positive reinforcements can range from positive encouraging comments, electronic items such as gifs and images provided to the employee/agent, actual rewards via gamification (swag, monetary bonus, etc.), or the like.

In some embodiments, a likelihood determination can trigger an automated closed loop interaction by the employer (via a closed loop notification system), such as additional training, follow up meetings, or the like.

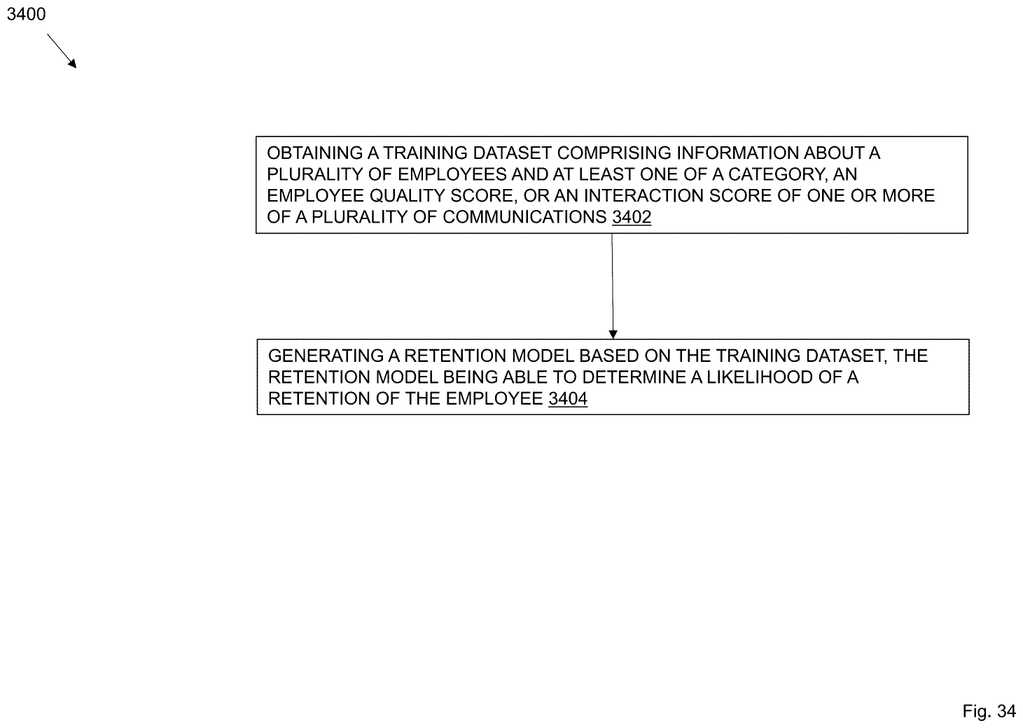

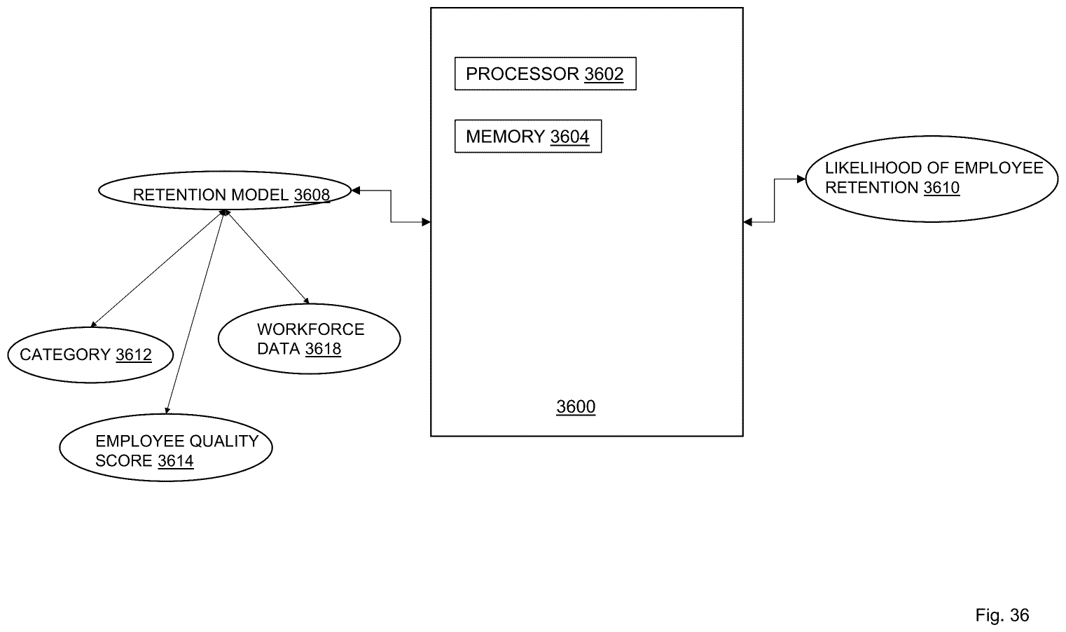

Referring now to FIG. 34, a procedure 3400 for predicting employee retention by generating a retention model is depicted. The procedure 3400 includes an operation 3402 of obtaining a training dataset comprising information about a plurality of employees and at least one of a category, an employee quality score, or an interaction score of one or more of the plurality of communications. The information may include at least one of employee scheduling, employee training, employee hierarchies, or workforce management, including information about employee retention (“workforce data”). The procedure 3400 may also include an operation 3404 of generating a retention model based on the training dataset, the retention model being able to determine a likelihood of a retention of the employee. In aspects, the category may be determined by analyzing acoustic and language characteristics of the plurality of communications. In aspects, the interaction score may be based on at least one acoustic, prosodic, syntactic, or visual feature of an interaction of the plurality of communications. The employee quality score may be based on at least one of a nature of customer interactions, an employee work hours and schedule, a training provided, a coaching feedback provided, an interaction quality, or frequency with supervisors. The employee quality score may be a measure of historical interaction scoring between an employee and one or more human customers. The retention model may be configured to generate the likelihood of the employee's retention based on receiving at least one of a category, an employee quality score, or a workforce data for an employee and predicting, via the trained model, the likelihood of the employee's retention. Based on the likelihood of the employee's retention, the procedure 3400 may further include delivering at least one positive reinforcement. The procedure 3400 may further include triggering an alert based on the likelihood. A corresponding system for predicting employee retention by generating a retention model is depicted in the block diagram of FIG. 36. A system 3600 may include one or more processors 3602 and one or more computer-readable hardware storage devices, also known as a memory 3604, having stored computer-executable instructions that are executable by the one or more processors 3602 to cause the system 3600 to at least obtain a retention model 3608 configured through training to determine a likelihood of employee retention 3610, receive at least one of a category 3612, an employee quality score 3614, or a workforce data 3618 for an employee, and predict, via the retention model 3608, the likelihood of the employee's retention 3610. The employee quality score 3614 may be a measure of historical interaction scoring between the employee and human customers. Workforce data 3618 may include at least one of employee scheduling, employee training, employee hierarchies, or workforce management, including information about employee retention.

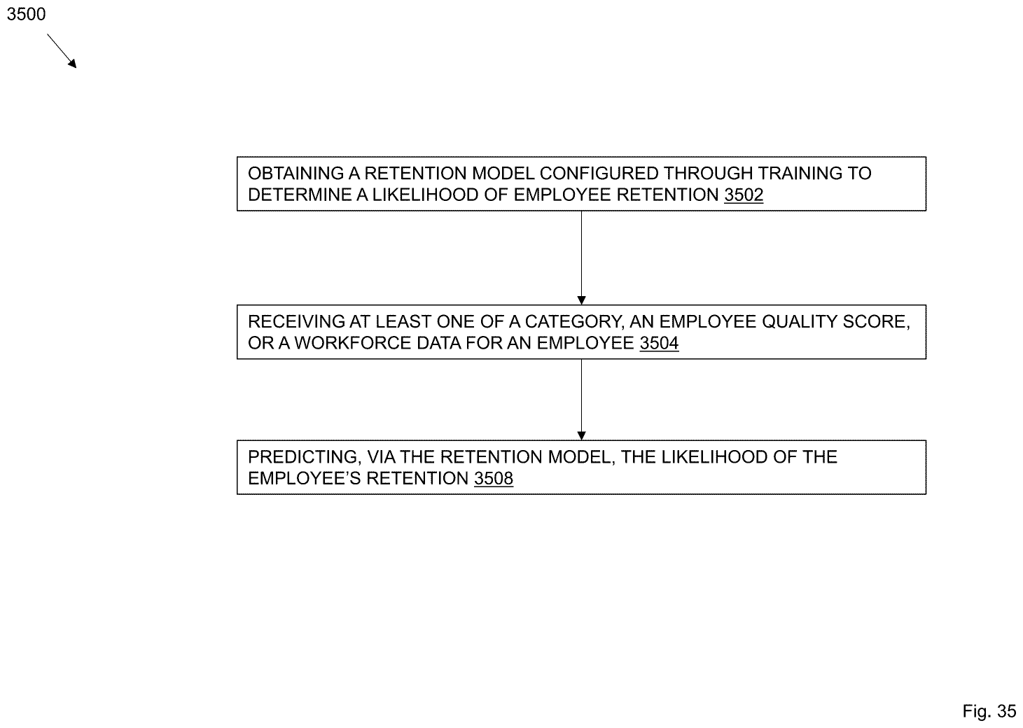

Referring now to FIG. 35, a procedure 3500 for predicting employee retention with a retention model is depicted. The procedure 3500 may include an operation 3502 of obtaining a retention model configured through training to determine a likelihood of employee retention. The procedure 3500 may include an operation 3504 of receiving at least one of a category, an employee quality score, or a workforce data for an employee. The procedure 3500 may include an operation 3508 of predicting, via the retention model, the likelihood of the employee's retention. The employee quality score may be a measure of historical interaction scoring between the employee and human customers. Workforce data may include at least one of employee scheduling, employee training, employee hierarchies, or workforce management, including information about employee retention.

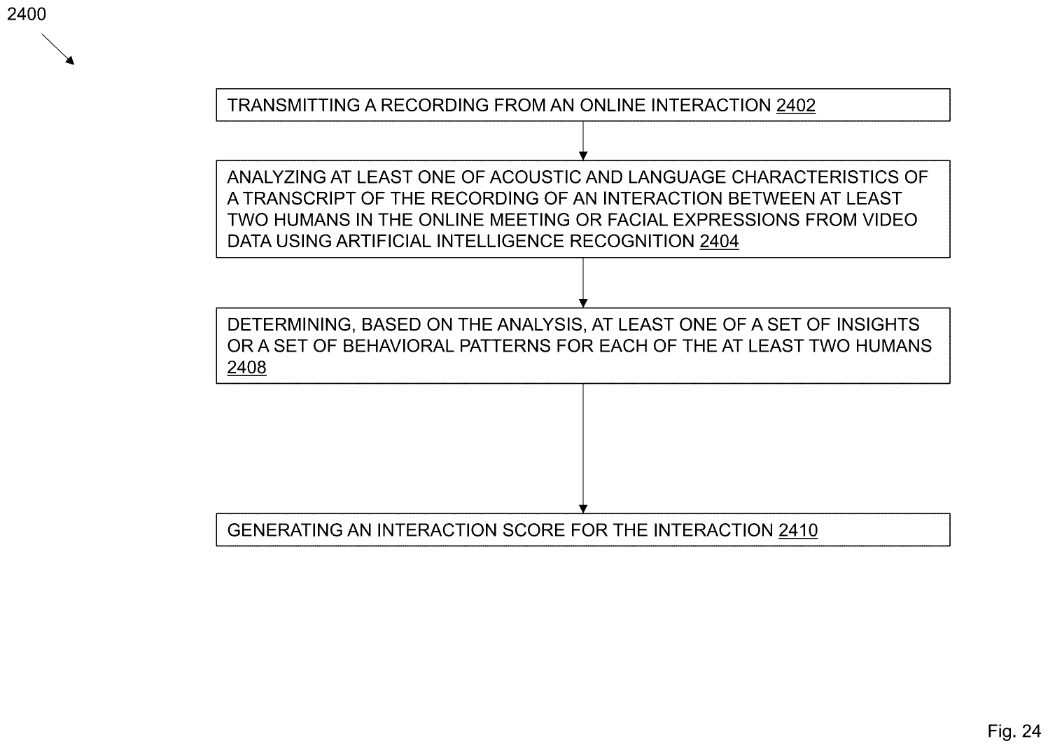

Referring now to FIG. 24, a method 2400 may include transmitting a recording from an online interaction 2402, including at least one of a text, an audio, or a video data, analyzing at least one of acoustic and language characteristics of a transcript of the recording of an interaction between at least two humans in the online meeting or facial expressions from video data using artificial intelligence recognition 2404, such as an emotion recognition model configured through training to recognize emotions from facial expressions, determining, based on the analysis, at least one of a set of insights or a set of behavioral patterns for each of the at least two humans 2408, and generating an interaction score for the interaction 2410. The interaction may include a coaching session or an online meeting, and the insights produced may be targeted to the interaction type. The transcript may include at least one of a text chat, a transcription of a spoken voice interaction, or a combination of a text chat and a transcription of a spoken voice interaction. Analyzing may be performed after the interaction has concluded, concurrently during the interaction, or in real-time during the interaction. Analyzing may include analyzing the transcript for data corresponding to at least one of coaching effectiveness behaviors, coaching experiences, employee engagement, customer satisfaction or success, product mentions, sentiments, process questions, competitive insights, product level insights, win-loss analysis, or employee wellbeing.

Analysis of the acoustic and language characteristics may be done using systems and methods disclosed in U.S. Pat. No. 9,413,891, which is incorporated herein by reference in its entirety. The analysis of the acoustic and language characteristics may also be determined using a machine learning model trained to recognize emotions from the acoustic and language characteristics. This machine learning model could be trained through supervised learning based on data labeled with language or acoustic characteristics indicating different emotions such as sadness, happiness, angry, etc.

Also, databases of audio clips for different human emotions may also be a source of training data. A model could be trained on such a dataset to identify the emotion. Some datasets are Crema, available at (https://wwww.kaggle.com/datasets/ejlok1/cremad), Savee, available at (https://www.kaggle.com/datasets/ejlok1/surrey-audiovisual-expressed-emotion-savee), Tess available at (https://www.kaggle.com/datasets/ejlok1/toronto-emotional-speech-set-tess), Ravee available at (https://www.kaggle.com/datasets/uwrfkaggler/ravdess-emotional-speech-audio), and the like.

Similarly, facial expressions could be used to determine human emotion. Several databases exist for human emotion, and a machine learning model could be generated from such datasets using supervised, unsupervised, or semi-supervised learning. Some of the databases include FER-2013, available at (https://www.kaggle.com/datasets/deadskull7/fer2013), EMOTIC dataset available at (https://s3.sunai.uoc.edu/emotic/index.html) and other datasets.

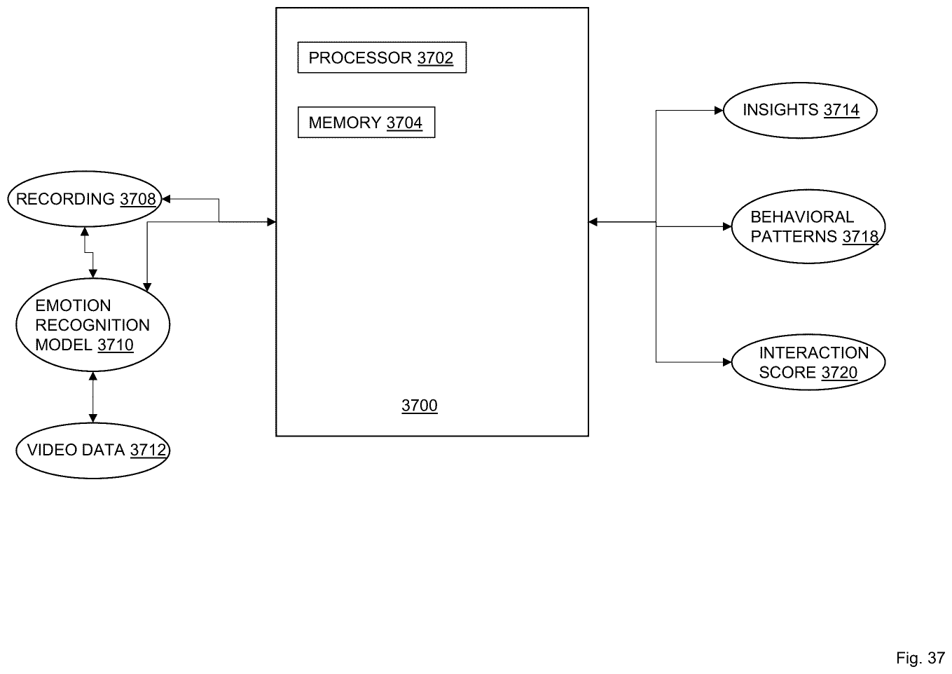

In aspects, and referring to FIG. 37, a system 3700 for analyzing interactions may include one or more processors 3702, and one or more computer-readable hardware storage devices (aka memory 3704) having stored computer-executable instructions that are executable by the one or more processors to cause the system to at least transmit a recording 3708 from an online interaction to a processor 3702, including at least one of a text, an audio, or a video data, analyze, with the processor 3702, at least one of acoustic and language characteristics of a transcript of the recording 3708 of an interaction between at least two humans in the online interaction or facial expressions from video data 3712 using an emotion recognition model 3710 configured through training to recognize emotions from facial expressions, determine, based on the analysis, at least one of a set of insights 3714 or a set of behavioral patterns 3718 for each of the at least two humans, and generate an interaction score 3720 for the interaction. The interaction may include a coaching session or an online meeting, and the insights produced may be targeted to the interaction type. The transcript may include at least one of a text chat, a transcription of a spoken voice interaction, or a combination of a text chat and a transcription of a spoken voice interaction. Analyzing may be performed after the interaction has concluded, concurrently during the interaction, or in real-time during the interaction. Analyzing may include analyzing the transcript for data corresponding to at least one of coaching effectiveness behaviors, coaching experiences, employee engagement, customer satisfaction or success, product mentions, sentiments, process questions, competitive insights, product level insights, win-loss analysis, or employee wellbeing.

In embodiments, an interaction score may be a summary or ensemble score based on the elements or features of the interaction that, in this case, would drive retention (e.g., target variable). These include acoustic, prosodic, syntactic, and visual measures that can be analyzed to create a score of all or a portion of that interaction based on desired outcome or target variable. The scores may be determined either through desired behavior, behavior known to the creator, or using an “outcome” modeling process of a population of interactions that have the desired result or target variable (e.g., populations that have attrited or been retained in this example). The elements or features are assembled from the common elements of each target population.

In embodiments, various analyses may be used to obtain an interaction score. In an aspect, correlation analysis is used, which involves feature relationships with statistical significance to gauge the impact on outcome or target variable. In another aspect, feature importance analysis is used, which calculates a score for each feature or element based on the importance to that given outcome or target variable. In yet another aspect, regression analysis is used, which estimates the importance of each feature in the ability to drive the outcome to target variable.

In embodiments, for any of these analyses, variables may include any system driven feature, meta data, and target variable, such as categories, scores, model outputs such as sentiments or topic predictions, entities, prosodic measures such as rate of speech or gain, facial expressions, acoustics, or the like. In embodiments, the source of the variables may be the system for analyzing interactions, the interaction transcribed or ingested, the recording of the interaction if applicable, or the like.

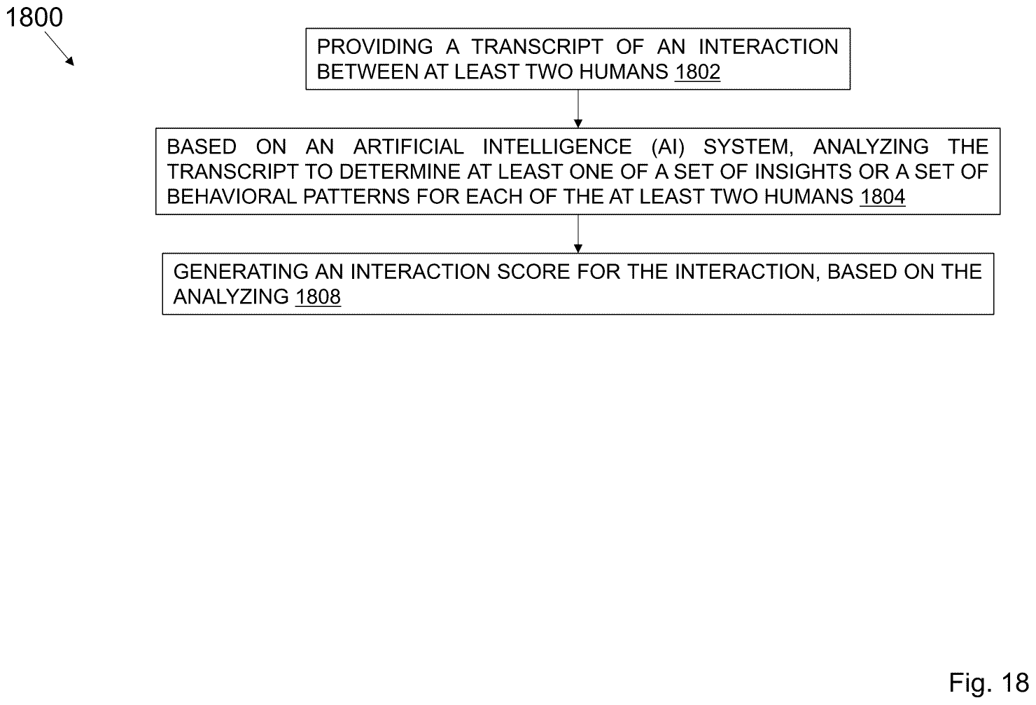

In an embodiment, and referring to FIG. 18, a method 1800 may include providing a transcript of an interaction between at least two humans (1802), based on an artificial intelligence (AI) system (e.g., coaching system 3000), analyzing the transcript to determine at least one of a set of insights or a set of behavioral patterns for each of the at least two humans (1804), and generating an interaction score for the interaction, based on the analyzing (1808).

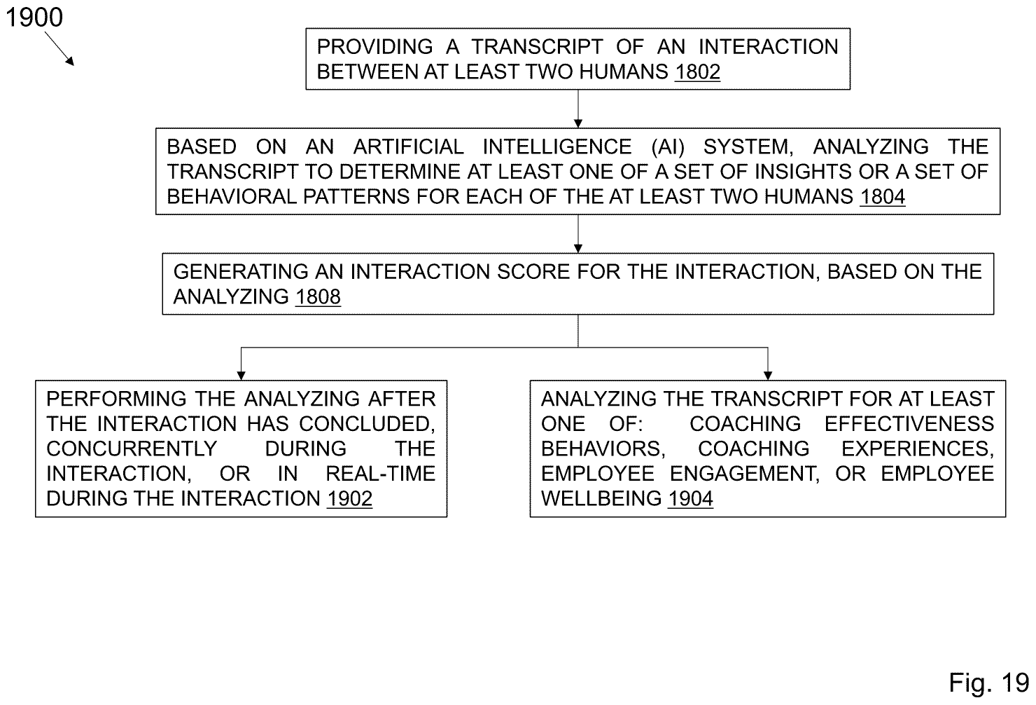

Referring to FIG. 19, in the method 1900, the analyzing may be performed after the interaction has concluded, concurrently during the interaction, or in real-time during the interaction (1902). In the method, the analyzing may include analyzing the transcript for data corresponding to at least one of: coaching effectiveness behaviors, coaching experiences, employee engagement, or employee wellbeing (1904). In the method, the interaction may include a coaching session. In the method, the interaction may include an online meeting. In the method, the transcript may include at least one of a text chat, a transcription of a spoken voice interaction, or a combination of a text chat and a transcription of a spoken voice interaction.

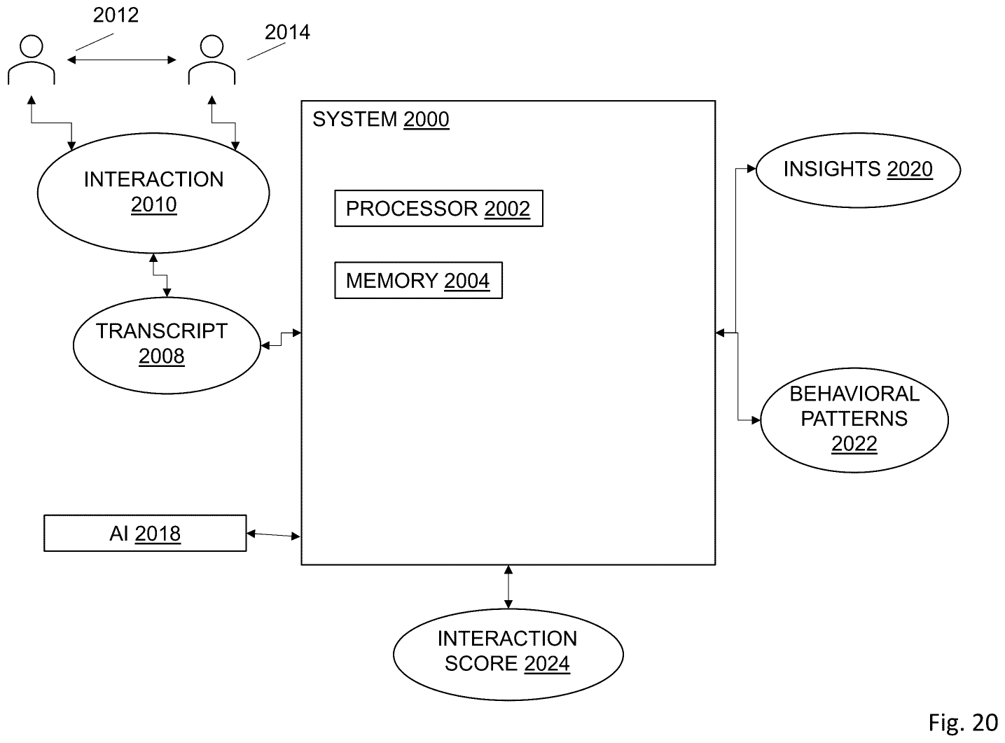

In an embodiment, and referring to FIG. 20, a system 2000 may include one or more processors 2002 and one or more computer-readable hardware storage devices, e.g., a memory 2004, having stored computer-executable instructions that are executable by the one or more processors 2002 to cause the system 2000 to at least: provide a transcript 2008 of an interaction 2010 between at least two humans 2012, 2014, based on an artificial intelligence (AI) system 2018, analyze the transcript 2008 to determine at least one of a set of insights 2020 or a set of behavioral patterns 2022 for each of the at least two humans 2012, 2014, and generate an interaction score 2024 for the interaction 2010, based on the analyzing.

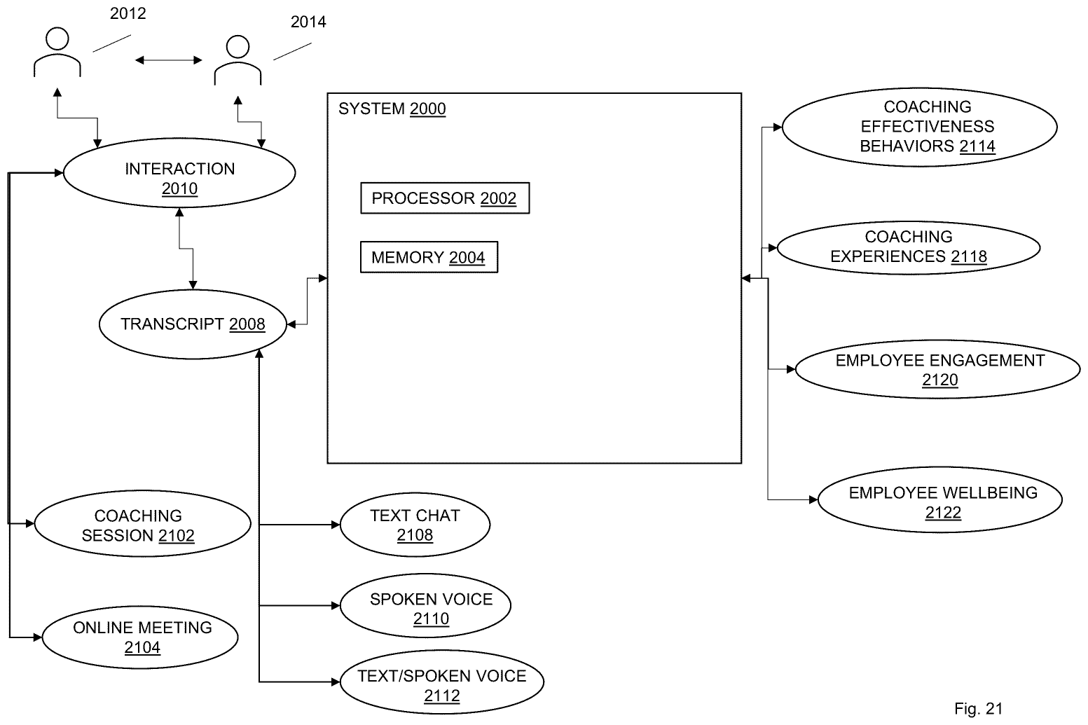

Referring to FIG. 21, in the system 2000, the interaction 2010 may include a coaching session 2102. In the system 2000, the interaction 2010 may include an online meeting 2104. In the system 2000, the transcript 2008 may include at least one of a text chat 2108, a transcription of a spoken voice interaction 2110, or a combination of a text chat and a transcription of a spoken voice interaction 2112. In the system 2000, the instructions may further cause the system 2000 to perform the analyzing after the interaction 2010 has concluded, concurrently during the interaction, or in real-time during the interaction 2010. In the system 2000, the analyzing may include analyzing the transcript 2008 for data corresponding to at least one of: coaching effectiveness behaviors 2114, coaching experiences 2118, employee engagement 2120, or employee wellbeing 2122.

As described herein, machine learning models may be trained using supervised learning or unsupervised learning. In supervised learning, a model is generated using a set of labeled examples, where each example has corresponding target label(s). In unsupervised learning, the model is generated using unlabeled examples. The collection of examples constructs a dataset, usually referred to as a training dataset. During training, a model is generated using this training data to learn the relationship between examples in the dataset. The training process may include various phases such as: data collection, preprocessing, feature extraction, model training, model evaluation, and model fine-tuning. The data collection phase may include collecting a representative dataset, typically from multiple users, that covers the range of possible scenarios and positions. The preprocessing phase may include cleaning and preparing the examples in the dataset and may include filtering, normalization, and segmentation. The feature extraction phase may include extracting relevant features from examples to capture relevant information for the task. The model training phase may include training a machine learning model on the preprocessed and feature-extracted data. Models may include support vector machines (SVMs), artificial neural networks (ANNs), decision trees, and the like for supervised learning, or autoencoders, Hopfield, restricted Boltzmann machine (RBM), deep belief, Generative Adversarial Networks (GAN), or other networks, or clustering for unsupervised learning. The model evaluation phase may include evaluating the performance of the trained model on a separate validation dataset to ensure that it generalizes well to new and unseen examples. The model fine-tuning may include refining a model by adjusting its parameters, changing the features used, or using a different machine-learning algorithm, based on the results of the evaluation. The process may be iterated until the performance of the model on the validation dataset is satisfactory and the trained model can then be used to make predictions.

In embodiments, trained models may be periodically fine-tuned for specific user groups, applications, and/or tasks. Fine-tuning of an existing model may improve the performance of the model for an application while avoiding completely retraining the model for the application.

In embodiments, fine-tuning a machine learning model may involve adjusting its hyperparameters or architecture to improve its performance for a particular user group or application. The process of fine-tuning may be performed after initial training and evaluation of the model, and it can involve one or more hyperparameter tuning and architectural methods.

Hyperparameter tuning includes adjusting the values of the model's hyperparameters, such as learning rate, regularization strength, or the number of hidden units. This can be done using methods such as grid search, random search, or Bayesian optimization. Architecture modification may include modifying the structure of the model, such as adding or removing layers, changing the activation functions, or altering the connections between neurons, to improve its performance.

Online training of machine learning models includes a process of updating the model as new examples become available, allowing it to adapt to changes in the data distribution over time. In online training, the model is trained incrementally as new data becomes available, allowing it to adapt to changes in the data distribution over time. Online training can also be useful for user groups that have changing usage habits of the stimulation device, allowing the models to be updated in almost real-time.

In embodiments, online training may include adaptive filtering. In adaptive filtering, a machine learning model is trained online to learn the underlying structure of the new examples and remove noise or artifacts from the examples.

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems disclosed herein. The terms computer, computing device, processor, circuit, and/or server, as utilized herein, should be understood broadly.

Any one or more of the terms computer, computing device, processor, circuit, and/or server include a computer of any type, capable to access instructions stored in communication thereto such as upon a non-transient computer readable medium, whereupon the computer performs operations of systems or methods described herein upon executing the instructions. In certain embodiments, such instructions themselves comprise a computer, computing device, processor, circuit, and/or server. Additionally or alternatively, a computer, computing device, processor, circuit, and/or server may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware, computers, computing devices, processors, circuits, and/or servers include, without limitation, a general purpose computer, a server, an embedded computer, a mobile device, a virtual machine, and/or an emulated version of one or more of these. Example and non-limiting hardware, computers, computing devices, processors, circuits, and/or servers may be physical, logical, or virtual. A computer, computing device, processor, circuit, and/or server may be: a distributed resource included as an aspect of several devices; and/or included as an interoperable set of resources to perform described functions of the computer, computing device, processor, circuit, and/or server, such that the distributed resources function together to perform the operations of the computer, computing device, processor, circuit, and/or server. In certain embodiments, each computer, computing device, processor, circuit, and/or server may be on separate hardware, and/or one or more hardware devices may include aspects of more than one computer, computing device, processor, circuit, and/or server, for example as separately executable instructions stored on the hardware device, and/or as logically partitioned aspects of a set of executable instructions, with some aspects of the hardware device comprising a part of a first computer, computing device, processor, circuit, and/or server, and some aspects of the hardware device comprising a part of a second computer, computing device, processor, circuit, and/or server.

A computer, computing device, processor, circuit, and/or server may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices utilized for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players, and the like. These mobile devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer to peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information. Operations including interpreting, receiving, and/or determining any value parameter, input, data, and/or other information include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first operation to interpret, receive, and/or determine a data value may be performed, and when communications are restored an updated operation to interpret, receive, and/or determine the data value may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g. where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The elements described and depicted herein, including in flow charts, block diagrams, and/or operational descriptions, depict and/or describe specific example arrangements of elements for purposes of illustration. However, the depicted and/or described elements, the functions thereof, and/or arrangements of these, may be implemented on machines, such as through computer executable transitory and/or non-transitory media having a processor capable of executing program instructions stored thereon, and/or as logical circuits or hardware arrangements. Example arrangements of programming instructions include at least: monolithic structure of instructions; standalone modules of instructions for elements or portions thereof, and/or as modules of instructions that employ external routines, code, services, and so forth; and/or any combination of these, and all such implementations are contemplated to be within the scope of embodiments of the present disclosure Examples of such machines include, without limitation, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements described and/or depicted herein, and/or any other logical components, may be implemented on a machine capable of executing program instructions. Thus, while the foregoing flow charts, block diagrams, and/or operational descriptions set forth functional aspects of the disclosed systems, any arrangement of program instructions implementing these functional aspects are contemplated herein. Similarly, it will be appreciated that the various steps identified and described above may be varied, and that the order of steps may be adapted to particular applications of the techniques disclosed herein. Additionally, any steps or operations may be divided and/or combined in any manner providing similar functionality to the described operations. All such variations and modifications are contemplated in the present disclosure. The methods and/or processes described above, and steps thereof, may be implemented in hardware, program code, instructions, and/or programs or any combination of hardware and methods, program code, instructions, and/or programs suitable for a particular application. Example hardware includes a dedicated computing device or specific computing device, a particular aspect or component of a specific computing device, and/or an arrangement of hardware components and/or logical circuits to perform one or more of the operations of a method and/or system. The processes may be implemented in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer readable instructions described above. All such permutations and combinations are contemplated in embodiments of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

1.-60. (canceled)

61. An interaction summarization system for automatically generating summary output, comprising:
one or more processors; and
one or more computer readable hardware storage devices having stored computer-executable instructions that are executable by the one or more processors to cause the interaction summarization system to at least:
generate a transcript from an interaction including content, the content including at least one of written text, audio speech, non-word symbols, metadata, silences, language characteristics, or acoustic characteristics, wherein the content is attributed to a participant in the interaction; and
generate an interaction summary of the transcript using at least one of an extractive machine learning summarization model or an abstractive machine learning summarization model that summarizes the content of the interaction.

62. The interaction summarization system of claim 61, wherein the abstractive machine learning summarization model is trained based on long form summarization.

63. The interaction summarization system of claim 61, wherein the abstractive machine learning summarization model is trained based on chunked/bucketed summarization.

64. The interaction summarization system of claim 61, wherein the abstractive machine learning summarization model is trained based on an interaction summary label/short sentence.

65. The interaction summarization system of claim 61, wherein the extractive machine learning summarization model is configured through training to identify at least one word or phrase from the content, the at least one word or phrase corresponding to the summary output of the interaction.

66. The interaction summarization system of claim 65, wherein the extractive machine learning summarization model is trained based on supervised learning for two-class labels.

67. The interaction summarization system of claim 66, wherein a first label is for summary content and a second label is for non-summary content.

68. A method for automatically generating summary output, comprising:
generating a transcript from an interaction including content, the content including at least one of written text, audio speech, non-word symbols, metadata, silences, language characteristics, or acoustic characteristics, wherein the content is attributed to a participant in the interaction; and
generating an interaction summary of the transcript using at least one of an extractive machine learning summarization model or an abstractive machine learning summarization model that summarizes the content of the interaction.

69. The method of claim 68, wherein the abstractive machine learning summarization model is trained based on long form summarization.

70. The method of claim 68, wherein the abstractive machine learning summarization model is trained based on chunked/bucketed summarization.

71. The method of claim 68, wherein the abstractive machine learning summarization model is trained based on an interaction summary label/short sentence.

72. The method of claim 68, wherein the extractive machine learning summarization model is configured through training to identify at least one word or phrase from the content, the at least one word or phrase corresponding to the summary output of the interaction.

73. The method of claim 72, wherein the training is based on supervised learning for two-class labels.

74. The method of claim 73, wherein a first label is for summary content and a second label is for non-summary content.

75. A non-transitory computer-readable medium having stored thereon instructions that, in response to execution, cause a processor to perform operations, the operations, comprising:
generating a transcript from an interaction including content, the content including at least one of written text, audio speech, non-word symbols, metadata, silences, language characteristics, or acoustic characteristics, wherein the content is attributed to a participant in the interaction; and
generating an interaction summary of the transcript using at least one of an extractive machine learning summarization model or an abstractive machine learning summarization model that summarizes the content of the interaction.

76. The non-transitory computer-readable medium of claim 75, wherein the abstractive machine learning summarization model is trained based on long form summarization.

77. The non-transitory computer-readable medium of claim 75, wherein the abstractive machine learning summarization model is trained based on chunked/bucketed summarization.

78. The non-transitory computer-readable medium of claim 75, wherein the abstractive machine learning summarization model is trained based on an interaction summary label/short sentence.

79. The non-transitory computer-readable medium of claim 75, wherein the extractive machine learning summarization model is configured through training to identify at least one word or phrase from the content, the at least one word or phrase corresponding to the interaction summary of the interaction.

80. The non-transitory computer-readable medium of claim 79, wherein the training is based on supervised learning for two-class labels, wherein a first label is for summary content and a second label is for non-summary content.

81.-214. (canceled)
